(19) United States
(12) Patent Application Publication
(10) Pub. No.: US 2024/0140831 A1
(43) Pub. Date: May 2, 2024

(54) WATER TREATMENT DEVICE WITH INTERNAL CHAMBER

(71) Applicants: THE UNIVERSITY OF BRITISH COLUMBIA, Vancouver (CA); ACUVA TECHNOLOGIES INC., Burnaby (CA)

(72) Inventors: Fariborz TAGHIPOUR, Burnaby (CA); Babek Adeli KOUDEHI, Vancouver (CA); Majid KESHAVARZFATHY, Burnaby (CA); Milad Raeiszadeh OSKOUEI, Vancouver (CA); Ehsan ESPID, Burnaby (CA); Ian David LEWIS, Ferndale, WA (US)

(21) Appl. No.: 18/492,759

(22) Filed: Oct. 23, 2023

Related U.S. Application Data
(63) Continuation of application No. PCT/CA2022/050667, filed on Apr. 29, 2022.
(60) Provisional application No. 63/182,642, filed on Apr. 30, 2021.

(51) Int. Cl. C02F 1/32

(52) U.S. Cl. CPC C02F 1/325; C02F 2201/002

(57) ABSTRACT

A UV reactor comprises a reactor body shaped to define longitudinally extending inner and outer reactor chambers. One or more passages located at a first longitudinal end of the inner reactor chamber provide fluid communication between the inner and outer reactor chambers. The outer reactor chamber surrounds a portion of the inner reactor chamber that includes the first longitudinal end. The UV reactor also comprises: an inlet/outlet in fluid communication with the outer reactor chamber; and an outlet/inlet in fluid communication with the inner reactor chamber. The outlet/inlet is located at a second longitudinal end of the inner reactor chamber. A cap connected to the reactor body houses one or more UV radiation emitters optically oriented to direct UV radiation into the inner reactor chamber. An inner fluid-flow cross-section of the inner reactor chamber may be greater than an outer fluid flow cross-section of the outer reactor chamber.

### REFERENCE TO RELATED APPLICATIONS

This application is a continuation of Patent Cooperation Treaty (PCT) application No. PCT/CA2022/050667 having an international filing date of 29 Apr. 2022 which in turn claims priority from, and for the purposes of the United States the benefit under 35 USC 119 in relation to, U.S. patent application No. 63/182,642 filed 30 Apr. 2021. All of the applications referred to in this paragraph are hereby incorporated herein by reference.

### TECHNICAL FIELD

The present invention relates generally to fluid treatment reactors, and more particularly, to fluid treatment reactors that include an ultraviolet (UV) emitter. Particular embodiments have example applications for treating and/or disinfecting water.

### BACKGROUND

UV photoreactors are reactors that administer UV radiation. UV reactors typically contain a UV source administering UV radiation to a fluid flowing through a chamber or conduit. Common UV sources include low and medium pressure mercury lamps. UV reactors are typically used to facilitate various photoreactions, photocatalytic reactions, and photo-initiated reactions. Example commercial applications for UV reactors include water and air purification.

Light emitting diodes (LEDs) are semiconductor (solid state) radiation sources that emit photons when an electric potential is applied across the LED. LEDs typically emit radiation with narrow bandwidths. For some applications, the radiation emitted by LEDs is of sufficiently narrow bandwidth to be considered to be effectively monochromatic. LEDs can emit radiation in the ultraviolet (UV) region of the electromagnetic spectrum. Advantageously, such ultraviolet LEDs (UV-LEDs) can be designed to generate UV radiation at different wavelengths for different applications (e.g. DNA absorption, photocatalyst activation, etc.). Accordingly, UV-LEDs are sometimes used as the primary UV source in a UV reactor.

It is known to use UV-LEDs for irradiating fluids in UV photoreactors (e.g. for applications such as water disinfection). One issue with state of the art UV reactors is that there is considerable variation in the radiant power distribution of UV-LEDs, which, in turn, can result in an uneven radiant fluence rate distribution in a photoreactor. Fluence rate (in W/m2) is the radiant flux (power) passing from all directions through an infinitesimally small sphere of cross-sectional area dA, divided by dA. Another issue in photoreactor design is that there is typically variation in the velocity distribution of a fluid (e.g. water) flowing through the reactor, which, in turn, can result in variation in residence time distribution of fluid travelling through the reactor. Either or both of these issues can cause a considerably wide range of UV dose (a product of fluence rate and residence time) distribution delivered to fluid elements passing through the UV reactor. In other words, the variation in the UV fluence rate distribution and/or the variation in the fluid velocity distribution may undesirably permit parts of the fluid to flow through a UV reactor without receiving sufficient UV dose. This problem is sometimes referred to as “short-circuiting” in the field of UV disinfection.

There is a general desire to prevent, minimize or otherwise mitigate short-circuiting in UV reactors. There is also a general desire to enhance dose uniformity delivered to fluids passing through a UV reactor.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

Aspects of the invention include, without limitation: ultraviolet (UV) reactors that may be operated to disinfect fluids such as water, method of manufacturing and/or assembling ultraviolet (UV) reactors described herein, etc.

One aspect of the invention provides an ultraviolet (UV) reactor for treating water or other fluids. The UV reactor comprises: a reactor body shaped to define inner and outer reactor chambers which extend in a longitudinal direction, the inner reactor chamber having one or more passages located at a first longitudinal end of the inner reactor chamber which provide fluid communication between the inner reactor chamber and the outer reactor chamber, the outer reactor chamber shaped to surround at least a portion of the inner reactor chamber that includes the first longitudinal end of the inner reactor chamber; an inlet/outlet in fluid communication with the outer reactor chamber; an outlet/inlet in fluid communication with at least one of the inner reactor chamber and the outer reactor chamber; and a cap housing one or more UV radiation emitters, the cap operatively connected to the reactor body, the one or more UV radiation emitters optically oriented to direct UV radiation into the inner reactor chamber. A first fluid-flow cross-section at an opening between the inlet/outlet and the outer reactor chamber is less than a minimum fluid-flow cross-section of the one or more passages.

The inlet/outlet may be in fluid communication with the outer reactor chamber at a location spaced longitudinally apart from the first longitudinal end of the reactor chamber.

The outlet/inlet may be in fluid communication with the inner reactor chamber at a second longitudinal end of the inner reactor chamber. The second longitudinal end of the inner reactor chamber may be opposed to the first longitudinal end of the inner reactor chamber.

A first average fluid velocity through the opening in a direction orthogonal to the first fluid-flow cross-section may be greater than a second average velocity through the minimum fluid-flow cross-section in a direction orthogonal to the minimum fluid-flow cross-section.

Another aspect of the invention provides an ultraviolet (UV) reactor for treating water or other fluids. The UV reactor comprises: a reactor body shaped to define inner and outer reactor chambers which extend in a longitudinal direction, the inner reactor chamber having one or more passages located at a first longitudinal end of the inner reactor chamber which provide fluid communication between the inner reactor chamber and the outer reactor chamber, the outer reactor chamber shaped to surround at least a portion of the inner reactor chamber that includes the first longitudinal end of the inner reactor chamber; an inlet/outlet in fluid communication with the outer reactor chamber; an outlet/inlet in fluid communication with at least one of the inner reactor chamber and the outer reactor chamber; and a cap housing one or more UV radiation emitters, the cap operatively connected to the reactor body, the one or more UV radiation emitters optically oriented to direct UV radiation into the inner reactor chamber. An inner fluid-flow cross-section of the inner reactor chamber in a cross-sectional plane having a normal parallel to the longitudinal direction is greater than an outer fluid flow cross-section of the outer reactor chamber in the cross-sectional plane.

The inlet/outlet may be in fluid communication with the outer reactor chamber at a location spaced longitudinally apart from the first longitudinal end of the reactor chamber.

The outlet/inlet may be in fluid communication with the inner reactor chamber at a second longitudinal end of the inner reactor chamber, the second longitudinal end of the inner reactor chamber opposed to the first longitudinal end of the inner reactor chamber.

An inner average velocity of the fluid in the inner reactor chamber may be less than an outer average velocity of the fluid in the outer reactor chamber.

The inlet/outlet may be in fluid communication with the outer reactor chamber at a location spaced longitudinally apart from the first longitudinal end of the outer reactor chamber.

Another aspect of the invention provides an ultraviolet (UV) reactor for disinfecting water or other fluids, the UV reactor comprising: a reactor body shaped to define inner and outer reactor chambers which extend in a longitudinal direction, the inner reactor chamber having one or more passages located at a first longitudinal end of the inner reactor chamber which provide fluid communication between the inner reactor chamber and the outer reactor chamber, the outer reactor chamber shaped to surround at least a portion of the inner reactor chamber that includes the first longitudinal end of the inner reactor chamber; an inlet/outlet in fluid communication with the outer reactor chamber at a location spaced longitudinally apart from a first longitudinal end of the outer reactor chamber; an outlet/inlet in fluid communication with the inner reactor chamber at a second longitudinal end of the inner reactor chamber, the second longitudinal end of the inner reactor chamber opposed to the first longitudinal end of the inner reactor chamber; and a cap housing one or more UV radiation emitters, the cap operatively connected to the reactor body, the one or more UV radiation emitters optically oriented to direct UV radiation into the inner reactor chamber. An inner fluid-flow cross-section of the inner reactor chamber in a cross-sectional plane having a normal parallel to the longitudinal direction is greater than an outer fluid flow cross-section of the outer reactor chamber in the cross-sectional plane to thereby cause an inner average velocity of the fluid in the inner reactor chamber to be less than an outer average velocity of the fluid in the outer reactor chamber.

An inner average velocity of the fluid in the inner reactor chamber may be less than an outer average velocity of the fluid in the outer reactor chamber.

The inlet/outlet may be in fluid communication with the outer reactor chamber at a location spaced longitudinally apart from the first longitudinal end of the outer reactor chamber.

The inner fluid-flow cross-section of the inner reactor chamber may be greater than an inlet fluid-flow cross-section of the inlet in an inlet cross-sectional plane having a normal parallel to a flow direction in the inlet.

The inner fluid-flow cross-section of the inner reactor chamber may be greater than an outlet fluid-flow cross-section of the outlet in an outlet cross-sectional plane having a normal parallel to a flow direction in the outlet.

The outer fluid-flow cross-section of the outer reactor chamber is greater than an inlet fluid-flow cross-section of the inlet in an inlet cross-sectional plane having a normal parallel to a flow direction in the inlet.

The outer fluid-flow cross-section of the outer reactor chamber may be greater than an outlet fluid-flow cross-section of the outlet in an outlet cross-sectional plane having a normal parallel to a flow direction in the outlet.

The reactor body may comprise: an inner body member having a tubular portion which extends in the longitudinal direction and an inner surface which defines the inner reactor chamber; and an outer body member having a tubular portion and an end wall portion located at the second longitudinal end of the outer reactor chamber, the end wall portion shaped to have an opening, an interior surface of the tubular portion and an outer surface of the inner body member collectively defining the outer reactor chamber. The inner body member may be connected to the outer body member at the second longitudinal end of the outer reactor chamber.

The inner body member may comprise a transversely extending member that extends in at least one direction that has a directional component that is orthogonal to the longitudinal direction.

The transversely extending member may be proximal to the second longitudinal end and at least a surface of the transversely extending member facing the first longitudinal end is reflective of the UV radiation emitted by the UV radiation emitters.

The transversely extending member may be proximal to the outlet/inlet and at least a surface of the transversely extending member facing the first longitudinal end is reflective of the UV radiation emitted by the UV radiation emitters.

The inlet/outlet may be defined in the tubular portion of the outer body member.

The outlet/inlet may be defined in the end wall portion of the outer body member.

The cap may be operatively connected to the outer body member at the first longitudinal end of the outer reactor chamber.

The cap may be permanently secured to the outer body member at the first longitudinal end.

The cap may be detachably coupled to the outer body member at the first longitudinal end. The cap may be detachably coupled to the outer body member by way of one or more of a threaded connection, a snap-fit and o-ring seals.

The inner surface of the inner body member may comprise a UV reflective material.

The UV reflective material may be a dominantly diffuse UV reflective material suitable for reflecting UV radiation emitted by the one or more UV radiation emitters in a predominantly diffuse fashion.

The inner surface of the inner body member may be coated with a protective layer of UV-transparent material.

The inner body member may be transparent. The interior surface of the tubular portion of the outer body member may comprise a UV reflective material. The UV reflective material on the interior surface of the tubular portion of the outer body member may be a dominantly specular UV reflective material suitable for reflecting UV radiation emitted by the one or more UV radiation emitters in a predominantly specular fashion. The UV reflective material on the interior surface of the tubular portion of the outer body member may be a dominantly diffuse UV reflective material suitable for reflecting UV radiation emitted by the one or more UV radiation emitters in a predominantly diffuse fashion.

An inner surface of the end wall portion of the outer body member may comprise a UV reflective material.

The inner body member and the tubular portion of the outer body member may be annular in cross-section in the cross-sectional plane. The inner body member and the tubular portion of the outer body member may be co-centric.

The UV reactor may further comprise a diffuser located in the outer reactor chamber. The diffuser may have a diffuser body and a plurality of perforations extending through the diffuser body. The diffuser body may be tubular shaped to conform to the shape of the inner body member and the tubular portion of the outer body member. The diffuser body may be connected to the outer surface of the inner body member and connected to the tubular portion of the outer body member. The perforations may be spaced circumferentially around the tubular shaped diffuser body. The perforations may be evenly spaced around the circumference of the diffuser body. The perforations may be circular, triangular, rectangular, or hexagonal shaped in cross-section. The perforations may extend in directions parallel to the longitudinal direction. The perforations may extend in directions that have a component orthogonal to the longitudinal direction. Adjacent ones of the plurality of perforations may be different in size.

The UV reactor may further comprise a diffuser located in the outer reactor chamber. The diffuser may comprise a mesh or other porous material.

The one or more UV radiation emitters may be located in a cavity of the cap. The cap may comprise a UV-transparent window positioned to isolate the one or more UV radiation emitters from the fluid flowing through the reactor body.

The UV-transparent window may comprise a curved portion. The curved portion may comprise a concave surface facing the one or more UV radiation emitters and a convex surface facing the inner reactor chamber. The curved portion may comprise a varying radius of curvature. The curved portion may comprise a constant radius of curvature. The UV reactor may comprise a radial seal between a first surface of the UV transparent window that has a first surface normal within 15° of orthogonal to the longitudinal direction and a complementary surface of the cap or a heat-conducting insert located in a concavity of the cap, the complementary surface having a complementary surface normal within 15° of orthogonal to the longitudinal direction. The radial seal may be effected at least in part by an O-ring located between the first surface and the complementary surface. The extension of the UV-transparent window in directions orthogonal to the longitudinal direction may be less than a dimension on the inner reactor chamber in such directions.

The UV reactor may comprise a reflector cone disposed around the one or more UV radiation emitters.

The UV reactor may comprise one or more lenses located between the one or more UV radiation emitters and the UV-transparent window.

The one or more UV radiation emitters may be supported by a thermally conductive insert, the thermally conductive insert in thermal contact with the inner reactor chamber and/or outer reactor chamber of the reactor body.

The UV reactor may comprise one or more mixing elements located in the outer reactor chamber.

The UV reactor may comprise one or more inner-chamber mixing elements located in the inner reactor chamber. The inner-chamber mixing elements may be transparent to UV radiation.

The inner body member may be connected to the outer body member by insert molding. At least one of the inlet/outlet and the outlet/inlet may be integrally formed with the outer body member in a one body mold.

The inner body member and outer body member may be fabricated from UV-resistant material.

Electrical power may be provided to the one or more UV radiation emitters via a sealed conduit into the concavity of the cap via a portion of the cap that faces away from the inner reactor chamber.

Another aspect of the invention provides a method for manufacturing such UV reactor. The method comprises: forming the inner body member, the outer body member, and the cap; mounting the one or more UV radiation emitters in the cavity of the cap and optically orienting the one or more UV radiation emitters to face toward the opening of the cap; securing the UV transparent window to an inner side wall of the cap at a location between the opening of the cap and the one or more UV radiation emitters; coupling a rim of the inner body member to the outer body member at a second longitudinal end of the outer reactor chamber; and coupling the opening of the cap with the one or more UV radiation emitters housed therein to the outer body member.

Mounting the one or more UV radiation emitters in the cavity may comprise coupling the one or more UV radiation emitters to the thermally conductive insert. Coupling of the one or more UV radiation emitters to the insert may comprise insert molding of the one or more UV radiation emitters to the insert.

Another aspect of the invention provides an ultraviolet (UV) reactor for disinfecting water or other fluids. The UV reactor comprises: a reactor body shaped to define primary and secondary reactor chambers which extend in a longitudinal direction and one or more passages located at a first longitudinal end of the primary reactor chamber which provide fluid communication between the primary reactor chamber and the secondary reactor chamber; an inlet/outlet in fluid communication with the secondary reactor chamber at a location spaced longitudinally apart from the first longitudinal end of the primary reactor chamber; an outlet/inlet in fluid communication with the primary reactor chamber at a second longitudinal end of the primary reactor chamber, the second longitudinal end of the primary reactor chamber opposed to the first longitudinal end of the primary reactor chamber; and a housing supporting one or more UV radiation emitters, the housing operatively connected to the reactor body, the one or more UV radiation emitters optically oriented to direct UV radiation into the primary reactor chamber. A fluid-flow cross-section of the primary reactor chamber in a cross-sectional plane having a normal parallel to the longitudinal direction is greater than an passage fluid flow cross-section of the one or more passages in a second cross-sectional plane having a second normal parallel to the longitudinal direction to thereby cause an average velocity of the fluid in the primary reactor chamber to be less than a passage average velocity of the fluid in the passages.

In addition to the exemplary aspects and embodiments described above, further aspects and embodiments will become apparent by reference to the drawings and by study of the following detailed descriptions. It is emphasized that the invention relates to all combinations of the above features and features recited in any of the claims being filed herewith, even if these features are recited in different claims.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a schematic side view of an ultraviolet (UV) reactor according to an example embodiment. FIG. 1A is a perspective sectional view of the FIG. 1 UV reactor. FIG. 1B is a side sectional view of the FIG. 1 UV reactor.

FIG. 2 is a side sectional view of an example embodiment of a UV reactor with a diffuser. FIGS. 2A-2C are perspective views of various diffusers suitable for use with the FIG. 2 UV reactor. FIGS. 2D-F are end views of various diffusers suitable for use with the FIG. 2 UV reactor.

FIG. 3 is a side sectional view of an example embodiment of UV reactor with a reflector. FIG. 3A is a side sectional view of an example embodiment of a UV reactor with a reflector and a lens.

FIG. 4 is a perspective view of an example embodiment of a UV reactor with two radiation emitters. FIG. 4A is a side sectional view of the FIG. 4 UV reactor.

FIG. 5 is a top view of another example embodiment of a UV reactor with two radiation emitters. FIG. 5A is a side sectional view of the FIG. 5 UV reactor with diffusers.

FIG. 5B is a side sectional view of the FIG. 5 UV reactor with various types of flow distributors.

FIG. 6 is a side sectional view of an UV reactor according to another example embodiment of the invention.

FIG. 7 is a side sectional view of an UV reactor according to another example embodiment of the invention.

FIG. 8 is a side sectional view of an example UV reactor with an inner member that has a component that extends in a direction that has a component that is orthogonal with the longitudinal axis of the example UV reactor.

FIG. 9 is a side sectional view of an example UV reactor with an inner member that has a component that extends in a direction that has a component that is orthogonal with the longitudinal axis of the example UV reactor.

FIG. 10 is a flowchart of a method of manufacturing a UV reactor of the type shown in FIG. 1 according to a particular embodiment.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

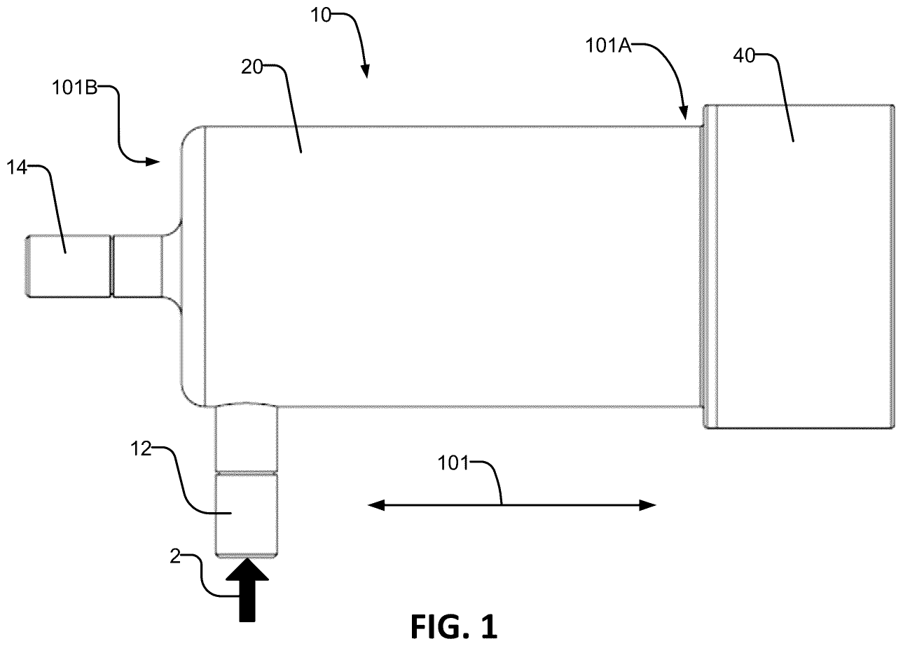

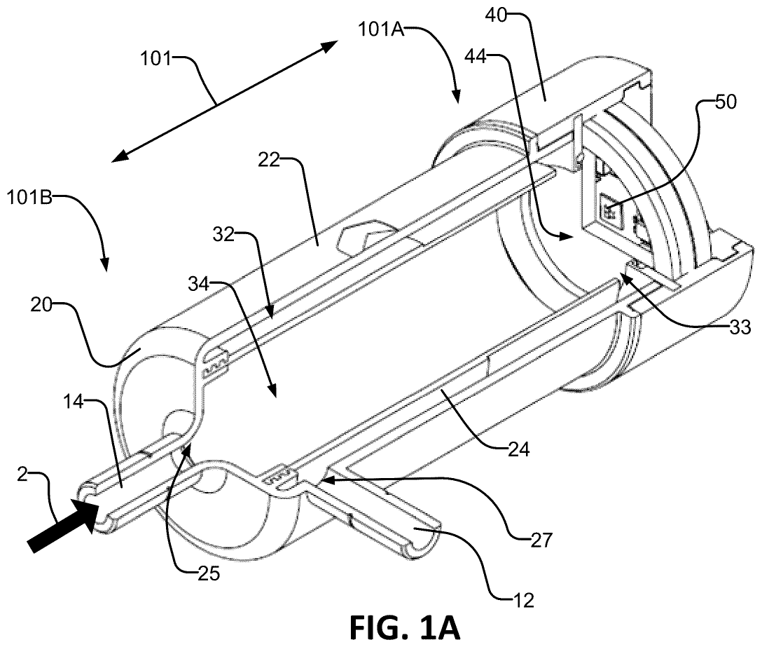

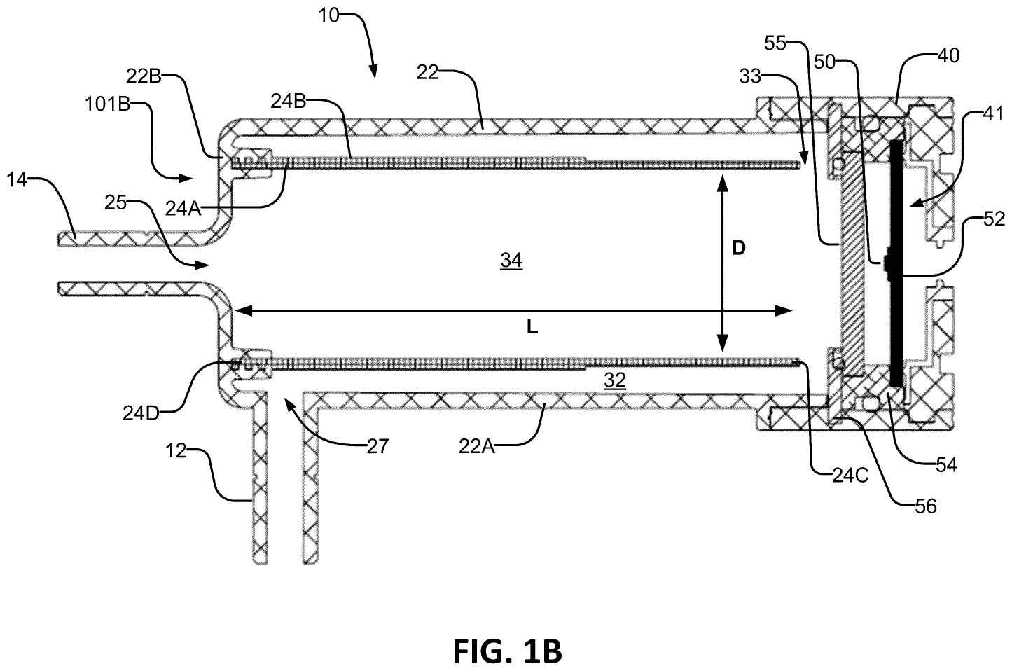

FIG. 1 is a schematic side view of an ultraviolet (UV) reactor 10 according to an example embodiment. UV reactor 10 has example applications for disinfecting fluid 2 (e.g. water) flowing therethrough. UV reactor 10 comprises a reactor body 20 extending in a longitudinal direction (indicated by double-headed arrow) 101. Reactor body 20 is operatively connected or otherwise coupled to a cap 40 at a first longitudinal end 101A of reactor body 20 as shown in FIG. 1. Reactor body 20 comprises a first port 12 and a second port 14. In a currently preferred embodiment, first port 12 functions as an inlet for introducing fluid 2 into reactor body 20 and second port 14 functions as an outlet for the egress of fluid 2 out of reactor body 20. In other embodiments, second port 14 functions as an inlet for introducing fluid 2 into reactor body 20 and first port 12 functions as an outlet for the egress of fluid 2 out of reactor body 20. Although the functions of first port 12 and second port are interchangeable, first port 12 is typically referred to herein as the “inlet” and second port 14 is typically referred to herein as the “outlet” for brevity. Unless the context dictates otherwise, it will be appreciated that either port 12, 14 could function as the inlet and the other one of ports 12, 14 could function as the outlet. In some places, this disclosure may refer to ports 12, 14 as “inlet/outlet” and “outlet/inlet” to indicate that either one of these ports 12, 14 could be the inlet (in which case the other is the outlet) or the outlet (in which case the other is the inlet). Port 12 may have an opening or orifice 27, which, in the illustrated embodiment, is located at the junction between port 12 and an outer reaction chamber 32 (described in more detail below). Similarly, port 14 may have an opening or orifice 25, which, in the illustrated FIG. 1 embodiment, is located at the junction between port 14 and an inner reactor chamber 34 (described in more detail below).

Cap 40 houses one or more ultraviolet (UV) radiation emitters 50 in a cavity 41 of cap 40 (e.g. see FIG. 1A). Cavity 41 may comprise a concavity defined by cap 40. Unless context dictates otherwise, the term “UV radiation emitter” (as used herein) should be understood to refer to devices which emit electromagnetic radiation that comprises at least some radiation having a wavelength shorter than that of the visible spectrum. UV radiation emitters 50 may be operated to emit UV radiation having wavelengths which are in the UV-C range (i.e. wavelengths that are particularly effective for neutralizing germs such as viruses, bacteria, etc.). In some embodiments, UV radiation emitters 50 may be designed to emit UV radiation having wavelengths which are on the order of about 100 nm to about 500 nm. In some embodiments, this UV radiation comprises UV-C radiation (˜200-290 nm).

Cap 40 comprises a UV transparent window 55 (e.g. a window made of quartz, other UV-transparent material and/or the like) located at an opening 44 of cap 40. Transparent window 55 of the FIG. 1 embodiment comprises two generally planar surfaces with surface normal that extend in longitudinal directions 101. One such planar surface of window 55 may be secured to a complementary surface of cap 40 (which may also have a surface normal that extends in one of longitudinal directions 101) using one or more face seals. Window 55 prevents fluid 2 from flowing into cavity 41 and physically contacting UV radiation emitters 50 (when cap 40 is coupled to reactor body 20). Window 55 is made of a UV transparent material (e.g. a material that is transparent at desired wavelengths of UV emitters 50) to provide an optical window for UV emitters 50 to direct UV radiation toward reactor body 20.

UV radiation emitter 50 is optically oriented to direct UV radiation through window 55 and toward fluid 2 as fluid 2 flows through UV reactor 10. That is, UV radiation emitter 50 is optically oriented to direct UV radiation in a principal direction that is generally parallel to longitudinal axis 101. Unless context dictates otherwise, the term “optically oriented” (as used herein) should be interpreted to imply that UV radiation emitter 50 may include optical elements (e.g. lenses, reflectors, waveguides, etc.) located in the optical path between a UV radiation source and an output of UV emitter 50 to emit UV that is principally oriented in a particular direction (e.g. within 5° of solid angle from the particular direction).

Referring now to FIG. 1A, reactor body 20 (and/or reactor body together with cap 40) is/are shaped to define an outer reactor chamber 32 and an inner reactor chamber 34. Both outer reactor chamber 32 and inner reactor chamber 34 extend in longitudinal direction 101. Outer reactor chamber 32 may have the cross-sectional shape of an annulus (i.e. in a cross-sectional plane having a normal extending in longitudinal direction 101). Inner reactor chamber 34 may be columnar shaped, and/or the like. In some embodiments, inner reactor chamber 34 is cylindrically shaped. While inner reactor chamber 34 of currently preferred embodiments has a circular cross-section (i.e. in a cross-sectional plane having a normal extending in longitudinal direction 101), this is not necessary and inner reactor chamber 34 may comprise other cross-sectional shapes. In some embodiments, outer reactor chamber 32 is co-centric with inner reactor chamber 34. Reactor body 20 (and/or reactor body together with cap 40) is/are also shaped to define one or more passages 33. Passages 33 may be located at first longitudinal end 101A of reactor body 20 as shown in FIG. 1A. Passages 33 are located between outer reactor chamber 32 and inner reactor chamber 34 to place outer reactor chamber 32 in fluid communication with inner reactor chamber 34. Passages 33 may extend in a direction that is orthogonal to longitudinal axis 101.

In the example embodiment illustrated in FIG. 1A, reactor body 20 comprises an outer body member 22 and an inner body member 24. Both outer body member 22 and inner body member 24 extend in longitudinal direction 101. Outer body member 22 and inner body member 24 are shaped and/or arranged to collectively define outer reactor chamber 32 and inner reactor chamber 34.

Inner body member 24 of the FIG. 1 embodiment is tubular in shape. As depicted in FIG. 1B, inner body member 24 comprises an inner surface 24A which defines inner reactor chamber 34 and an outer surface 24B which, together with outer body member 22, defines outer reactor chamber 32. Inner body member 24 also comprises opposing end surfaces or rims 24C, 24D. In some embodiments, first end surface 24C is located at first longitudinal end 101A to, together with a surface of cap 40, define passages 33. In some embodiments, second end surface 24D is located at a second longitudinal end 101B (i.e. an end opposed to first longitudinal end 101A) and mechanically connected to outer body member 22 (e.g. so that there is no fluid communication between outer reactor chamber 32 and inner reactor chamber 34 at second longitudinal end 101B.

Outer body member 22 has a tubular portion 22A and an end wall portion 22B located at second longitudinal end 101B of reactor body 20. End wall portion 22B of the FIG. 1 embodiment is shaped to define an opening or orifice 25 for placing inner reactor chamber 34 in fluid communication with outlet 14. In the illustrated FIG. 1 embodiment, orifice 25 is located at the junction between outlet 14 and inner reactor chamber 34. Preferably, orifice 25 is smaller in a fluid-flow cross-section (i.e. in a cross-sectional plane having a normal extending in longitudinal direction 101) compared to inner reactor chamber 34. Tubular portion 22A is shaped to define an opening or orifice 27 for placing outer reactor chamber 32 in fluid communication with inlet 12. In the illustrated FIG. 1 embodiment, orifice 27 is located at the junction between inlet 12 and outer reactor chamber 32. Preferably, orifice 27 is smaller in a fluid-flow cross-section compared to outer reactor chamber 32. Preferably, orifice 27 is smaller in a fluid-flow cross-section than a minimum fluid-flow cross-section of the one or more passages 33. Second end surface 24D of inner body member 24 may be connected to an inner surface of end wall portion 22B of the outer body member 22 as shown in FIG. 1B.

In the example embodiment illustrated in FIG. 1A, outer body member 22 and inner body member 24 are depicted as circular in cross section but this is not necessary. Outer body member 22 and inner body member 24 are depicted and described herein as circular in cross section for illustrative purposes only. Outer body member 22 and/or inner body member 24 may have any cross-sectional shape (e.g. elliptical, triangular, rectangular, hexagonal, etc.). Outer body member 22 and/or inner body member 24 may be shaped as suited to define outer reactor chamber 32 and/or inner reactor chamber 34 of any cross-sectional shape (e.g. in a cross-sectional plane having a normal extending in longitudinal direction 101).

In some embodiments, outer body member 22 and inner body member 24 are shaped and arranged to encourage a relatively uniform flow velocity in inner reactor chamber 34. As depicted in FIG. 1B, fluid 2 enters outer reactor chamber 32 through inlet 12 and flows through passages 33 before entering inner reactor chamber 34. Inlet 12 is typically smaller in cross section than outer reactor chamber 32. Since outer reactor chamber 32 has a larger cross-sectional surface area than inlet 12, fluid 2 entering outer reactor chamber 32 will lose its momentum as it flows through outer reactor chamber 32 and slow down before entering inner reactor chamber 34. Advantageously, the geometry and location of outer reactor chamber 32 and/or passages 33 can help reduce the high velocity of fluid 2 entering at inlet 12 (e.g. reduce “jet flow” velocity”). While outer reactor chamber 32 having a larger cross-sectional surface area than inlet 12 is one reason for the reduced velocity of fluid within reactor 10 (in particular within inner reactor chamber 34), there are other geometrical features that contribute to this aspect of the fluid flow in reactor 10. Such other geometrical factors include, for example, the flow from inlet 12 impacts the exterior surface 24B of inner body member 24, thereby reducing jet flow and redistributing more uniformly, the distance that the flow travels through annular outer reactor chamber 32 before entering inner reactor chamber 34 (as compared to flowing directly from inlet 12 into inner reactor chamber 34). These geometrical factors encourage fluid 2 to flow through inner reactor chamber 34 at a slower velocity and/or a more uniform velocity across the entire cross section of inner reactor chamber 34. That is, an inner average velocity of fluid 2 in inner reactor chamber 34 will be less than an outer average velocity of fluid 2 in outer reactor chamber 32 where the inner fluid-flow cross-section of inner reactor chamber 34 is greater than the outer fluid flow cross-section of outer reactor chamber 32.

In some embodiments, the distance between outer body member 22 and the outer surface 24B of inner body member 24 is designed or otherwise configured to encourage a relatively uniform distribution of the flow of fluid 2 through the inner reactor chamber 34.

In some embodiments, inner reactor chamber 34 may be characterized by a length dimension “L” parallel to longitudinal direction 101 and a diameter dimension “D”. In embodiments where inner reactor chamber 34 has a circular cross-section (i.e. in a cross-sectional plane having a normal extending in longitudinal direction 101), the diameter dimension “D” corresponds to the geometric diameter of the inner reactor chamber 34. In other embodiments, the diameter dimension “D” may correspond to the hydraulic diameter of inner reactor chamber 34 (i.e. D_{H}=4A/P, where A is the surface area of the cross section of inner reactor chamber 34 and P is the wetted perimeter of inner reactor chamber 34). In some embodiments, the length to diameter (i.e. L/D) aspect ratio of inner reactor chamber 34 may be designed to achieve a relatively uniform velocity profile across the entire cross section (i.e. a cross section having a normal parallel to longitudinal direction 101) of inner reactor chamber 34. In some embodiments, the length to diameter (i.e. L/D) aspect ratio of inner reactor chamber 34 is greater than or equal to 1. In some embodiments, the length to diameter (i.e. L/D) aspect ratio of inner reactor chamber 34 is between 2.0 and 3.5 (e.g. when inner body member 24 comprises a dominantly diffuse reflective inner surface 24A, as described below). In some embodiments, the length to diameter (i.e. L/D) aspect ratio of inner reactor chamber 34 is designed or otherwise configured based on the radiation profile inside inner reactor chamber 34 to maintain a desired fluence rate distribution.

In some embodiments, inner body member 24 or interior surface 24A of inner body member 24 is made of a UV reflective material and/or coated (e.g. on interior surface 24A) with materials suitable for reflecting UV radiation emitted by UV radiation emitter 50. In currently preferred embodiments, inner body member 24 comprises a dominantly diffuse reflective inner surface 24A made of or otherwise coated with materials suitable for reflecting UV radiation emitted by UV radiation emitter 50 in a diffuse fashion. Such dominantly diffuse reflective materials can advantageously encourage a relatively uniform radiation (e.g. fluence rate) profile inside inner reactor chamber 34. Examples of suitably reflective materials include, but are not limited to Polytetrafluoroethylene (PTFE), polycrystalline materials, Teflon, unpolished aluminum, etc. Additionally or alternatively, inner body member 24 may comprise a dominantly specular reflective inner surface 24A made of or otherwise coated with materials suitable for reflecting UV radiation emitted by UV radiation emitters 30 in a specular fashion. Examples of suitably reflective materials include, but are not limited to aluminum, PTFE, etc.

In some embodiments, inner body member 24 comprises a reflective outer surface 24B made of or otherwise coated with materials suitable for reflecting UV radiation emitted by UV radiation emitter 50 in a dominantly diffuse or dominantly specular fashion. In some embodiments, inner body member 24 comprises a reflective end surface 24C made of or otherwise coated with materials suitable for reflecting UV radiation emitted by UV radiation emitter 50 in a dominantly diffuse or dominantly specular fashion.

In some embodiments, outer body member 22 comprises a reflective end wall portion 22B made of or otherwise coated with materials suitable for reflecting UV radiation emitted by UV radiation emitter 50 in a dominantly diffuse or dominantly specular fashion. In some embodiments, outer body member 22 comprises a reflective tubular portion 22A made of or otherwise coated with materials suitable for reflecting UV radiation emitted by UV radiation emitter 50 in a dominantly diffuse or dominantly specular fashion.

The various surfaces of outer body member 22 and/or inner body member 24 may, optionally, be coated with a layer of UV-transparent material. For example, inner body member 24 may be at least partially coated with a layer of UV-transparent material over the reflective surface to prevent direct contact between water and the reflective surface(s) of inner body member 24. As another example, outer body member 22 may be at least partially coated with a layer of UV-transparent material over the reflective surface to prevent direct contact between water and the reflective surface(s) of outer body member 22. In some embodiments, inner body member 24 may be fabricated from transparent material while the various surfaces of outer body member 22 (e.g. tubular portion 22A and end wall portion 22B) are reflective (e.g. predominantly diffusely reflective or predominantly specularly reflective), so that radiation penetrates through inner body member 24 but is reflected back into inner body member 24 by the inwardly facing surfaces of outer body member 22.

As described elsewhere herein, reactor body 20 supports or is otherwise coupled to a cap 40 at first longitudinal end 101A. Cap 40 may be mechanically coupled to outer body member 22. In some embodiments, cap 40 is permanently coupled to outer body member 22 at first longitudinal end 101A during fabrication of reactor 10. In other embodiments, cap 40 is detachably coupled to outer body member 22 at first longitudinal end 101A. For example, cap 40 may be mechanically coupled to outer body member 22 through a threaded connection, a snap fit, o-ring seals, and/or the like.

When cap 40 is mechanically coupled to reactor body 12 (e.g. when cap 40 is mechanically coupled to outer body member 22), UV radiation emitter 50 housed therein is optically oriented to direct UV radiation toward inner reactor chamber 34. In some embodiments, UV radiation emitter 50 includes suitable optical elements (e.g. lenses, mirrors, etc.) for encouraging a relatively uniform radiation profile across the entire cross section of inner reactor chamber 34.

In some embodiments, UV radiation emitter 50 comprises one or more UV radiation sources (e.g. solid state UV radiation sources) coupled to a thermally conductive substrate 52 (e.g. a thermally conductive PCB). The thermally conductive substrate 52 may be in thermal contact with fluid 2 as fluid 2 flows through reactor body 20 of UV reactor 10. For example, substrate 52 may be physically supported by an insert 54 made of a thermally conductive material (e.g. metal) and insert 54 may be in thermal contact with fluid 2. In some embodiments, substrate 52 is insert molded to insert 54. In the example embodiment illustrated in FIG. 1B, insert 54 is made of a thermally conductive material and in direct physical contact with a thermally conductive frame 56 (e.g. a frame made of metal). Frame 56 physically supports window 55 and is in direct contact with fluid 2 flowing through outer reactor chamber 32 and/or passages 33. Advantageously, such construction and arrangement of substrate 52, insert 54, and frame 56 facilitates good heat transfer between UV radiation emitter 50 and fluid 2.

In some embodiments, insert 54 is a metal ring that encircles substrate 52 to hold substrate 52 snugly in place. In such embodiments, insert 54 may also at least partially encircle window 55. In the example illustrated in FIG. 1B, window 55 is secured between frame 56 and insert 54. This construction secures window 55 between inner reactor chamber 34 and UV radiation emitter 50 to prevent fluid 2 from flowing into cavity 41. Transparent window 55 of the FIG. 1 embodiment comprises two generally planar surfaces with surface normal that extend in longitudinal directions 101. One such planar surface of window 55 may be secured to a complementary surface of cap thermally conductive insert 54 (which may also have a surface normal that extends in one of longitudinal directions 101) using one or more face seals. The other planar surface of window 55 may be secured to a complementary surface of thermally conductive frame 56 (which may also have a surface normal that extends in one of longitudinal directions 101) using one or more face seals.

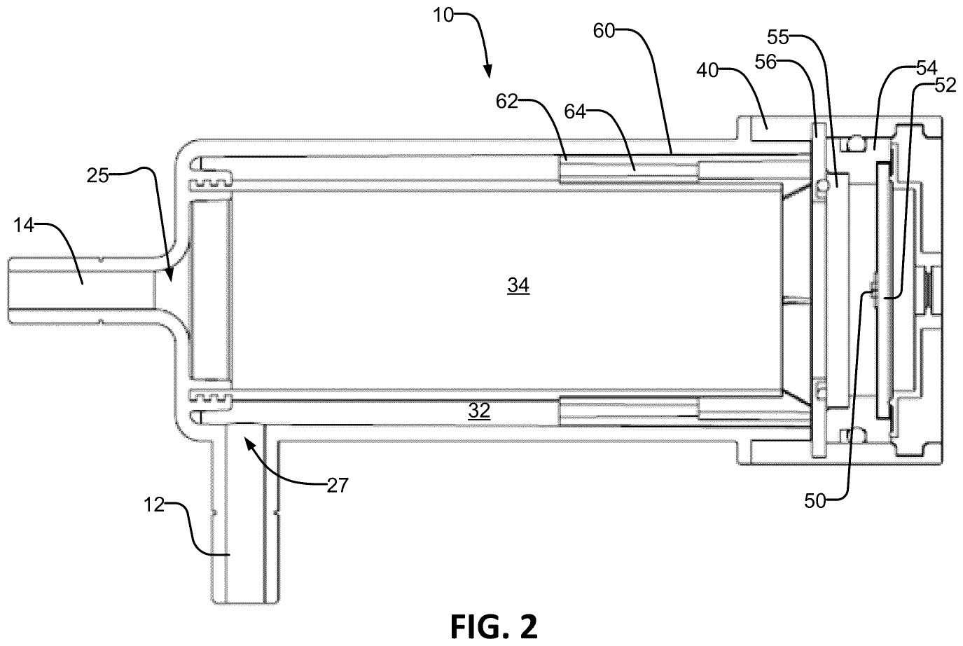

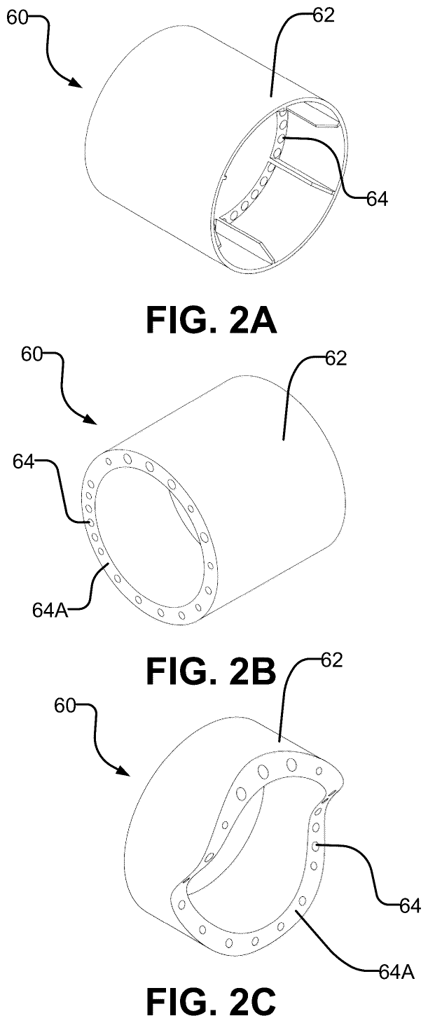

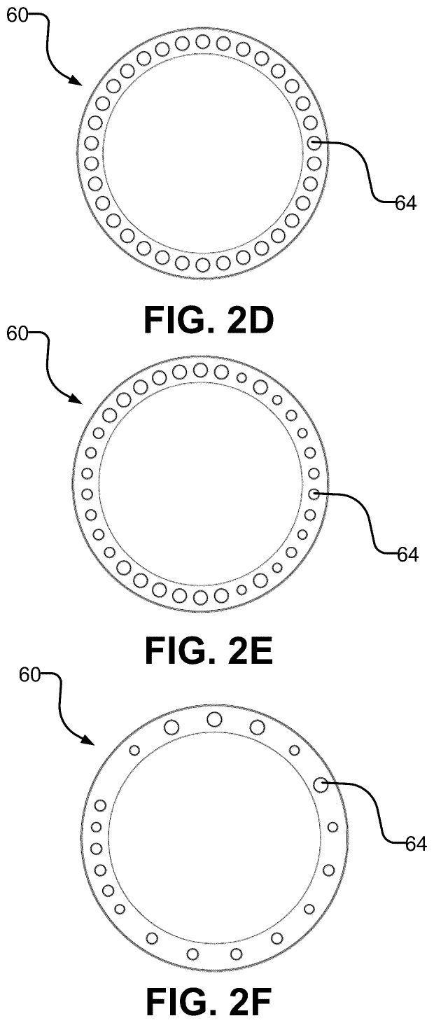

A wide range of variations and/or additions are possible. These variations and/or additions may be applied to any or all of the embodiments described herein, as suited. These variations and/or additions are described in more detail below with reference to FIGS. 2-6.

FIG. 2 is a side sectional view of an example embodiment of a UV reactor 10 with an optional diffuser 60. Diffuser 60 is located in outer reactor chamber 32. Diffuser 60 comprises a diffuser body 62 and one or more perforations 64 extending therethrough. Diffuser 60 may be designed or otherwise configured to control (e.g. shape) the velocity profile of fluid 2. For example, diffuser 60 may be designed or otherwise configured to align the flow of fluid 2 along longitudinal axis 101 and/or to provide a relatively uniform flow as fluid 2 flows through outer reactor chamber 32. Advantageously, this can encourage a higher positive correlation between the velocity profile of fluid 2 flowing through inner reactor chamber 34 and the radiation profile (i.e. the spatial distribution of radiation fluence rate) in inner reactor chamber 34. For example, if at one section of inner reactor chamber 34 the radiation fluence rate is higher, higher volume of fluid (higher velocity) can be directed to that section. As a result, the fluid leaving reactor 10 will receive a more uniform UV dose (fluence) of radiation. That is, diffuser 60 can be designed or otherwise configured to encourage a relatively uniform fluid velocity inside inner reactor chamber 34 to match the relatively uniform UV fluence rate distribution provided by UV radiation emitters 50. Alternatively or additionally, diffuser 60 be designed or otherwise configured to encourage relatively higher fluid velocities at locations inside inner reactor chamber 34 where a relatively higher UV fluence rate distribution is provided by UV radiation emitters 50 and/or relatively lower fluid velocities at locations inside inner reactor chamber 34 where a relatively lower UV fluence rate distribution is provided by UV radiation emitters. UV reactor 10 may include any number (e.g. 1, 2, 3 or more) of diffusers 60 coupled in series in outer reactor chamber 32.

In some embodiments, diffuser body 62 of diffuser 60 is tubular shaped. That is, diffuser body 62 may be tubular shaped to conform to the tubular shapes of outer body member 22 and inner body member 24. In such embodiments, diffuser body may fit snugly between outer body member 22 and the outer surface 24B of inner body member 24. This can help centralize inner reactor chamber 34 and/or provide improved mechanical integrity to UV reactor 10.

FIGS. 2A-2F illustrate various example embodiments of diffusers 60 having tubular shaped diffuser bodies 62. As described above, diffuser 60 comprises perforations 64 extending through diffuser body 62 (i.e. perforations that extend in a direction having a component parallel to longitudinal axis 101). Perforations 64 are depicted as circular in cross section in FIGS. 2A-F but this is not necessary. Perforations 64 are depicted as circular in cross section for illustrative purposes only. Perforations 64 may have any cross-sectional shape (e.g. elliptical, triangular, rectangular, hexagonal, etc.). The shape and/or location of perforations 64 may be designed or otherwise configured to slow down flow streams of fluid 2 with high velocity and/or to redistribute the flow stream of fluid 2 in a relatively uniform manner across the annular shaped outer reactor chamber 32.

As shown in FIGS. 2A-2F, perforations 64 are typically spaced around the circumference of diffuser body 62. In some embodiments, perforations 64 are evenly spaced around the circumference of diffuser body 62 (e.g. see FIG. 2A). In some embodiments, the size of all of the perforations 64 spaced around diffuser body 62 is the same (e.g. see FIG. 2D). In some embodiments, some or all of adjacent ones of perforations 64 spaced around the circumference of diffuser body 62 are different in size (e.g. see FIG. 2E) and/or spaced at different intervals (e.g. see FIG. 2F). In some embodiments, diffuser 60 includes perforations 64 that extend in directions parallel to longitudinal axis 101 (e.g. perforations 64 defined by surfaces 64A that have a normal vector parallel to longitudinal axis 101). In some embodiments, diffuser 60 includes perforations 64 that extend in directions with a component orthogonal to longitudinal axis 101 (e.g. perforations 64 defined by surfaces 64A that have a normal vector with a component orthogonal to longitudinal axis 101, see FIG. 2C). In such embodiments, some of perforations 60 are angled relative to longitudinal axis 101. The angled perforations 60 may be provided at locations where the velocity of fluid 2 is lower to accommodate higher fluid flow rates.

Diffuser 60 may include any suitable design or features for generating a desired hydrodynamic flow profile within inner reactor chamber 34. For example, diffuser 60 may include any suitable design or features for generating a relatively uniform flow profile across the entire cross sectional area of inner reactor chamber 34. These design considerations and/or features include, without limitation: the number of perforations 60 provided around diffuser body 62, the shape of each of the perforations 60, the spacing between adjacent ones of perforations 60, the size (e.g. diameter) of each of the perforations 60, the angle of each of the perforations 60 (i.e. relative to longitudinal axis 101), etc.

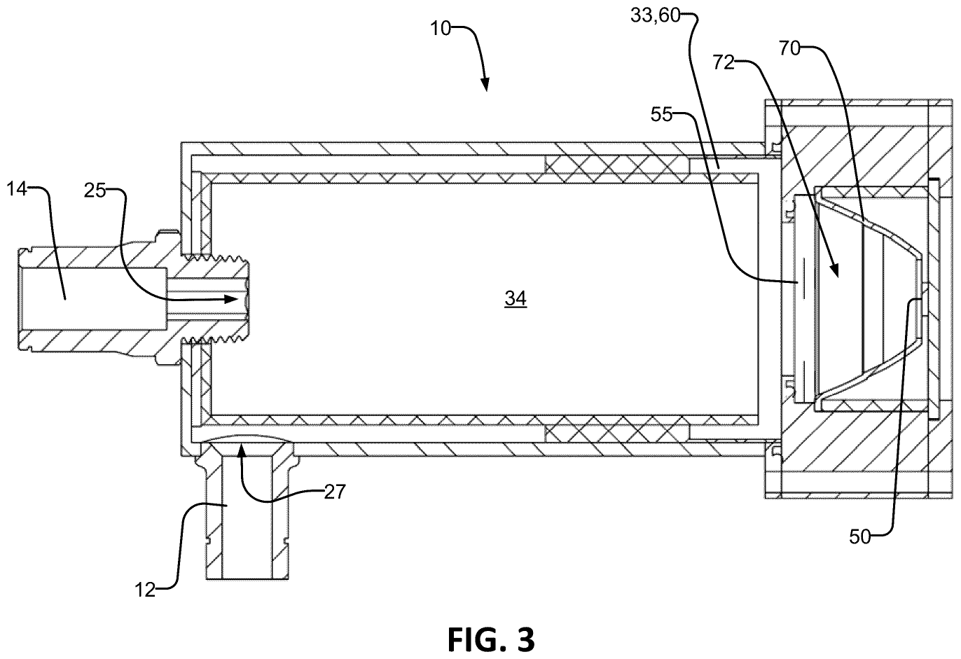

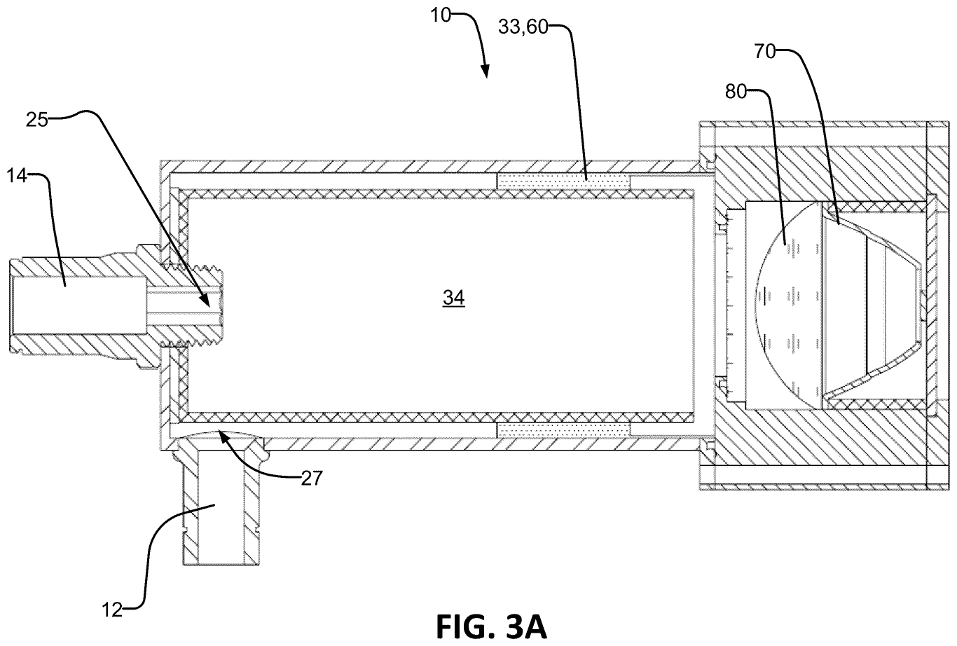

FIG. 3 is a side sectional view of an example embodiment of UV reactor 10 with an optional reflector cone 70 disposed around UV radiation emitter 50. Reflector cone 70 comprises a surface which is coated with or otherwise comprises a material that is reflective to radiation emitted by UV radiation emitter 50. Unless context dictates otherwise, reflector cone 70 need not be conically shaped in the strict sense. Instead, the term “cone” is used herein for convenience and/or brevity. In some embodiments, reflector cone 70 may be truncated such that it does not have a singular apex. Reflector cone 70 (which need not be strictly conical in shape) may be shaped to define a reflector cone concavity 72 having larger transverse cross-sectional areas (e.g. cross-sections on planes orthogonal to longitudinal direction 101 or having a normal vector parallel to longitudinal direction 101) at locations relatively further away from UV radiation emitter 50 along longitudinal direction 101 and smaller transverse cross-sectional areas at locations relatively closer to UV radiation emitter 50 along longitudinal direction 101. Reflector cone 70 may be shaped to focus, direct and/or collimate UV radiation emitted by UV radiation emitter 50.

FIG. 3A is a side sectional view of an example embodiment of a UV reactor 10 with optional reflector cone 70 and optional lens 80. Lens 80 is located in between reflector cone 70 and window 55. Lens 80 may be configured to direct UV radiation into inner reactor chamber 34 in a manner that generates a desired radiation profile in inner reactor chamber 34. For example, lens 80 may refract (e.g. collimate) radiation emitted by UV radiation emitter 50.

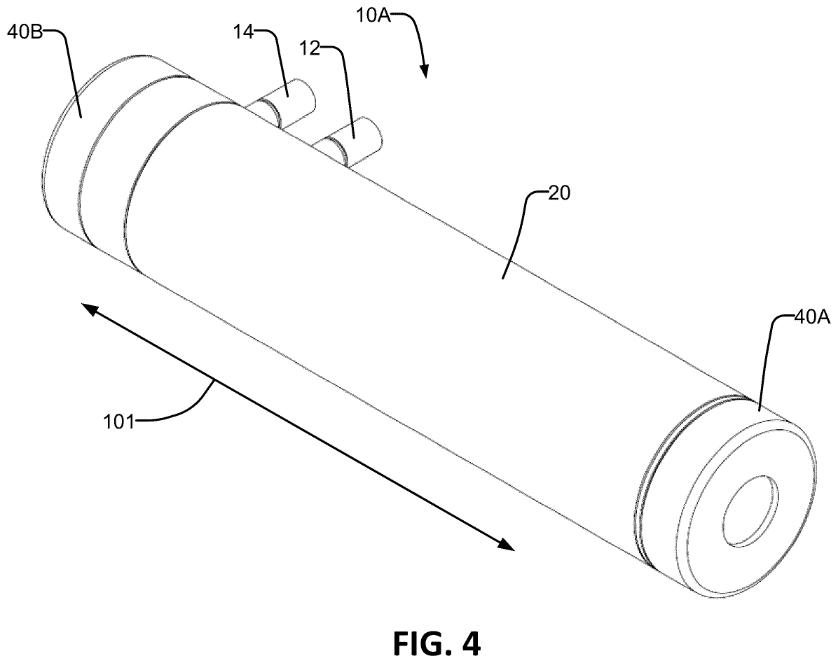

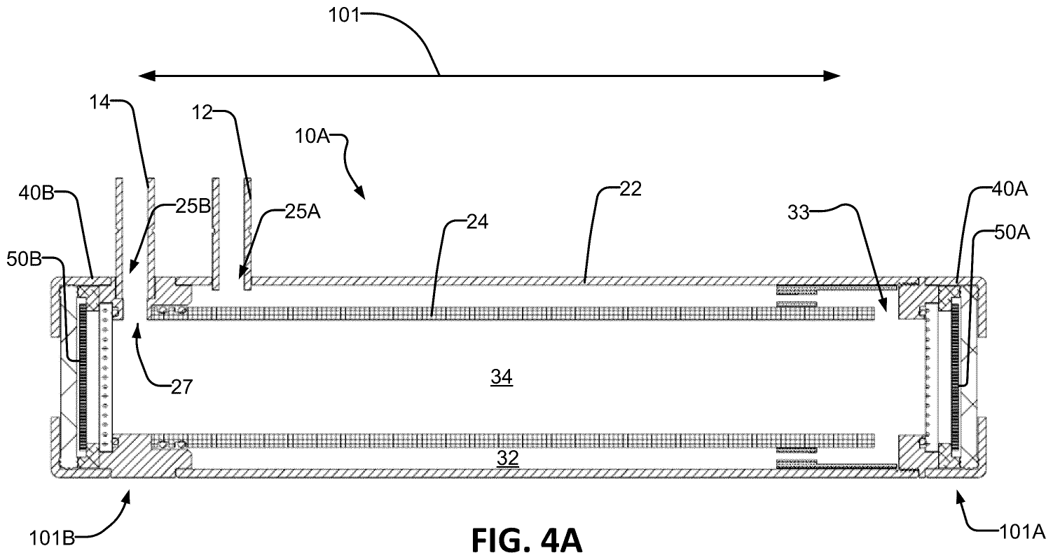

FIG. 4 is a perspective view of an example embodiment of a UV reactor 10A with two UV radiation emitters 50. UV reactor 10A comprises a reactor body 20 extending in longitudinal direction 101. Like UV reactor 10 described above, UV reactor 10A is shaped to define an outer reactor chamber 32 and an inner reactor chamber 34. UV reactor 10A supports or is otherwise coupled to a first cap 40A that houses one or more first UV radiation emitters 50A and a second cap 40B that houses one or more second UV radiation emitters 50B. Caps 40A, 40B may be permanently coupled to reactor body 20 or detachably coupled to reactor body 20. First cap 40A and second cap 40B are located at opposing ends of reactor body 20 as shown in FIG. 4. With this construction, first UV radiation emitters 50A are optically oriented to direct UV radiation from first longitudinal end 101A toward second longitudinal end 101B and second UV radiation emitters 50B are optically oriented to direct UV radiation from second longitudinal end 101B toward first longitudinal end 101A. Embodiments comprising UV emitters 50A, 50B at both longitudinal ends 101A, 101B can further enhance the radiation density inside of inner reactor chamber 34.

In the example embodiment illustrated in FIG. 4A, reactor body 20 of UV reactor 10A comprises an outer body member 22 and an inner body member 24. Both outer body member 22 and inner body member 24 are tubular shaped and extend in longitudinal direction 101.

Outer body member 22 is shaped to define first and second openings or orifices 25A, 25B formed on the tubular surface of outer body member 22. Inner body member 24 is shaped to define an opening or orifice 27 formed on the tubular surface of inner body member 24. First opening 25A of outer body member 22 is connected to inlet 12 to place outer reactor chamber 32 in fluid communication with inlet 12. First opening 25A of outer body member 22 may be located more proximate to second longitudinal end 101B than first longitudinal end 101A as shown in FIG. 4A. Second opening 25B of outer body member 22 is located more proximate to second end 101B than first opening 25A (i.e. second opening 25B is located closer to second longitudinal end 101B than first opening 25A is to second longitudinal end 101B). The opening 27 of inner body member 24 and second opening 25B of outer body member 22 are connected to outlet 14 to place inner reactor chamber 34 in fluid communication with outlet 14. Second opening 25B is suitably located to allow outlet 14 to extend therethrough as shown in FIG. 4A. In some embodiments, the opening 27 of inner body member 24 is co-axial with the second opening 25B of outer body member 22.

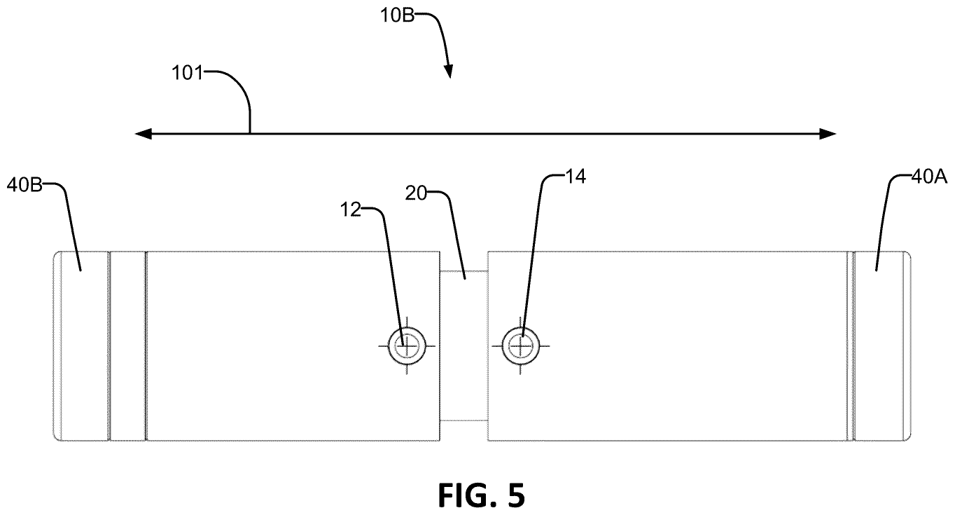

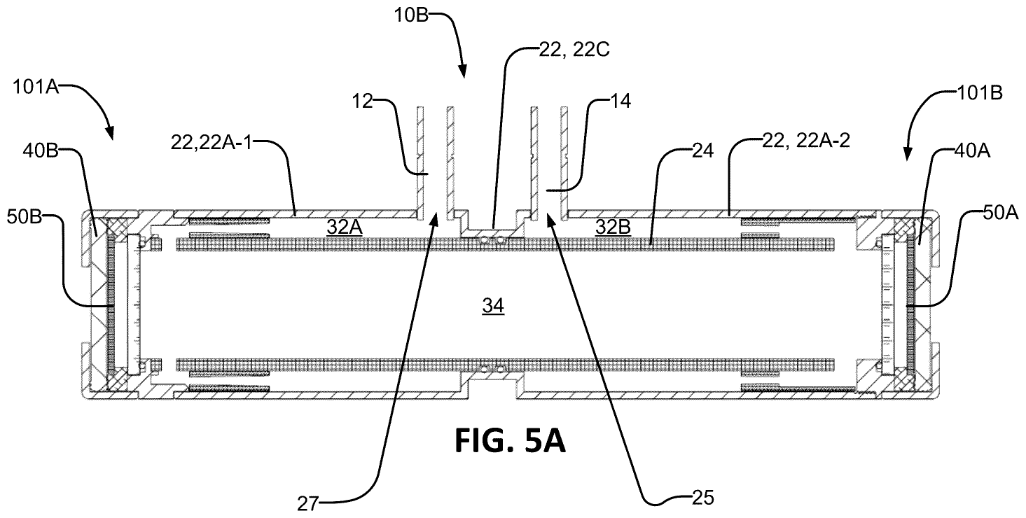

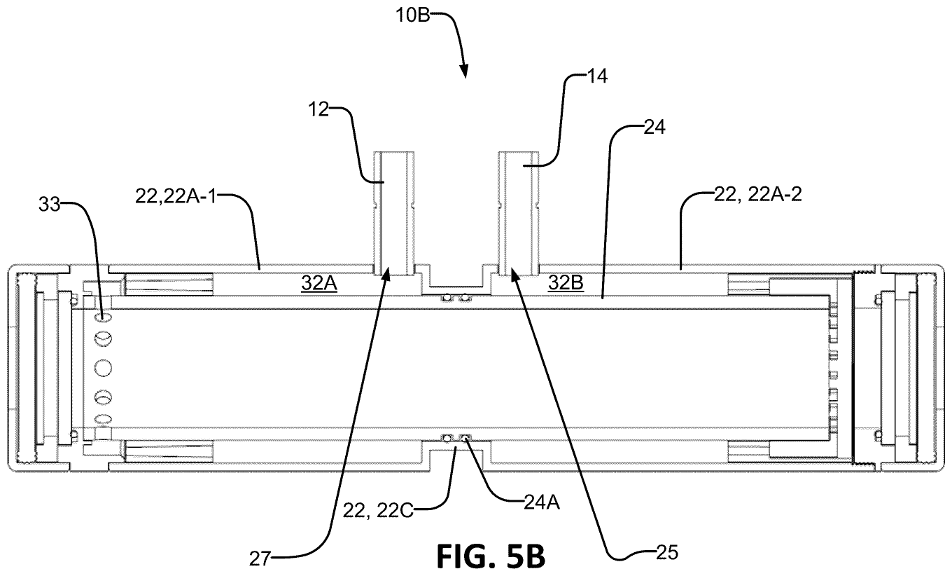

FIG. 5 and FIG. 5A are respectively top and cross-sectional views of another example embodiment of a UV reactor 10B with two radiation emitters 50. UV reactor 10B comprises a reactor body 20 extending in longitudinal direction 101. UV reactor 10B supports or is otherwise coupled to a first cap 40A that houses one or more first UV radiation emitters 50A and a second cap 40B that houses one or more second UV radiation emitters 50B. First cap 40A and second cap 40B are located at opposing ends of reactor body 20 as shown in FIG. 5.

Reactor body 20 of UV reactor 10B is shaped to define a first outer reactor chamber 32A, a second outer reactor chamber 32B, and an inner reactor chamber 34. First outer reactor chamber 32A is in fluid communication with inlet 12. Second outer reactor chamber 32B is in fluid communication with outlet 14. Inner reactor chamber 34 is located between first and second outer reactor chambers 32A, 32B. Reactor body 20 of UV reactor 10B is shaped to define passages 33 located at first longitudinal end 101A and second longitudinal end 101B. Passages 33 are located to place inner reactor chamber 34 is in fluid communication with first and second outer reactor chambers 32A, 32B.

FIG. 5B is a cross-sectional view of the FIG. 5 reactor 10B according to a particular embodiment where reactor body 20 of UV reactor 10B comprises an outer body member 22 and an inner body member 24. Outer body member 22 is tubular shaped and extends in longitudinal direction 101. Outer body member 22 comprises a depressed portion 22C located between a first tubular portion 22A-1 and a second tubular portion 22A-2. Inner body member 24 is tubular shaped and extends in longitudinal direction 101. A portion of the outer surface 24A of inner body member 24 is connected to the depressed portion 22C of outer body member 22 to define out reactor chambers 32A, 32B. In the FIG. 5B example embodiment, inner body member 24 is shaped to define passages 33 at a longitudinal end thereof. Passages 33 may be spaced around the circumferential surface off inner body member 24 as shown in FIG. 5B. Passages 33 may be shaped or otherwise designed to function as flow distributors that control the hydrodynamic profile of fluid 2 flowing in inner reactor chamber 34.

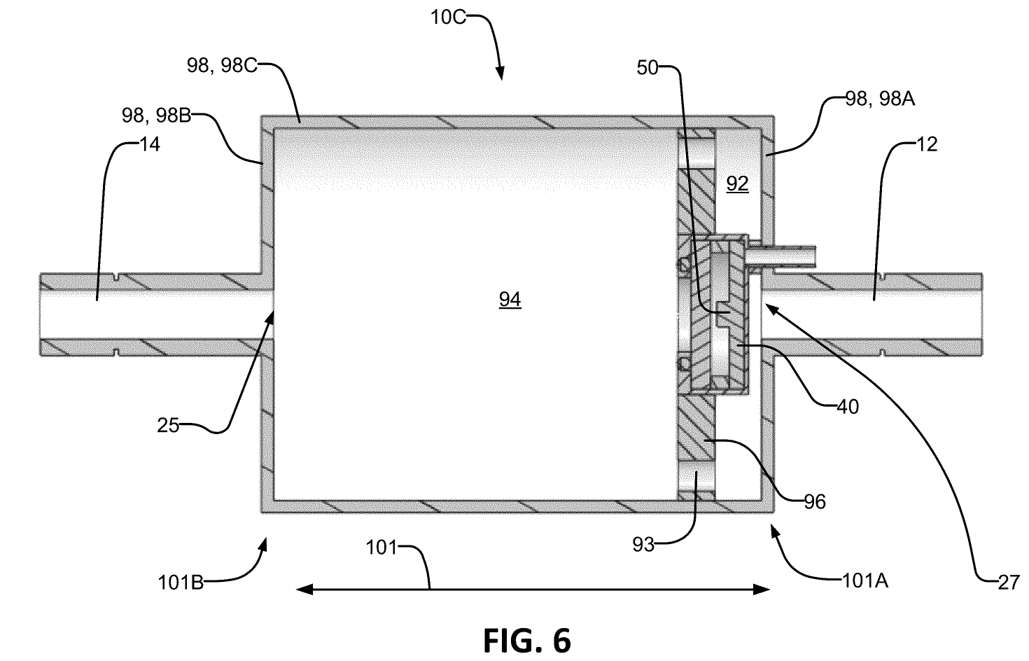

FIG. 6 is a side sectional view of an UV reactor 10C according to another example embodiment of the invention. UV reactor 10C comprises a reactor body 20 extending in longitudinal direction 101. Reactor body 20 is in fluid communication with an inlet 12 located at first longitudinal end 101A and an outlet 14 located at second opposing longitudinal end 101B. Inlet 12 and/or outlet 14 may extend in directions parallel to longitudinal direction 101 as shown in FIG. 6.

Reactor body 20 of UV reactor 10C is shaped to define a primary reactor chamber 94 and a secondary reactor chamber 92. Both primary reactor chamber 94 and secondary reactor chamber 92 extend in longitudinal direction 101. Both primary reactor chamber 94 and secondary reactor chamber 92 may be columnar shaped, although chambers 92, 94 need not have circular cross-sections (i.e. in planes having a normal parallel with longitudinal direction 101). Primary reactor chamber 94 typically has a larger volume than secondary reactor chamber 92.

In some embodiments, reactor body 20 of UV reactor 10C comprises an inner body member 96 and an outer body member 98. Outer body member 98 has a tubular portion 98C located between a first end wall portion 98A and a second end wall portion 98B. First end wall portion 98A is located at first longitudinal end 101A. Second end wall portion 98B is located at a second longitudinal end 101B. Inlet 12 may be located at first end wall portion 98A. Outlet 14 may be located at second end wall portion 98B.

Inner body member 96 is connected to outer body member 98 at tubular portion 98C to partition the volume defined by outer body member 98 into primary reactor chamber 94 and secondary reactor chamber 92. Inner body member 96 is shaped to define one or more passages 93 that place primary reactor chamber 94 in fluid communication with secondary reactor chamber 92. Passages 93 may be spaced circumferentially around inner body member 96. Passages 33 may include the features and/or have the functions of diffusers 60 described above to control the hydrodynamic profile of fluid 2 flowing into primary reactor chamber 94.

As depicted in FIG. 6, inner body member 96 supports a housing 40 that houses one or more UV radiation emitters 50. UV radiation emitters 50 are optically oriented to direct UV radiation toward primary reactor chamber 94. Housing 40 comprises a UV-transparent window 55 to prevent fluid 2 from entering cavity 41 of housing 40 and contacting UV radiation emitters 50.

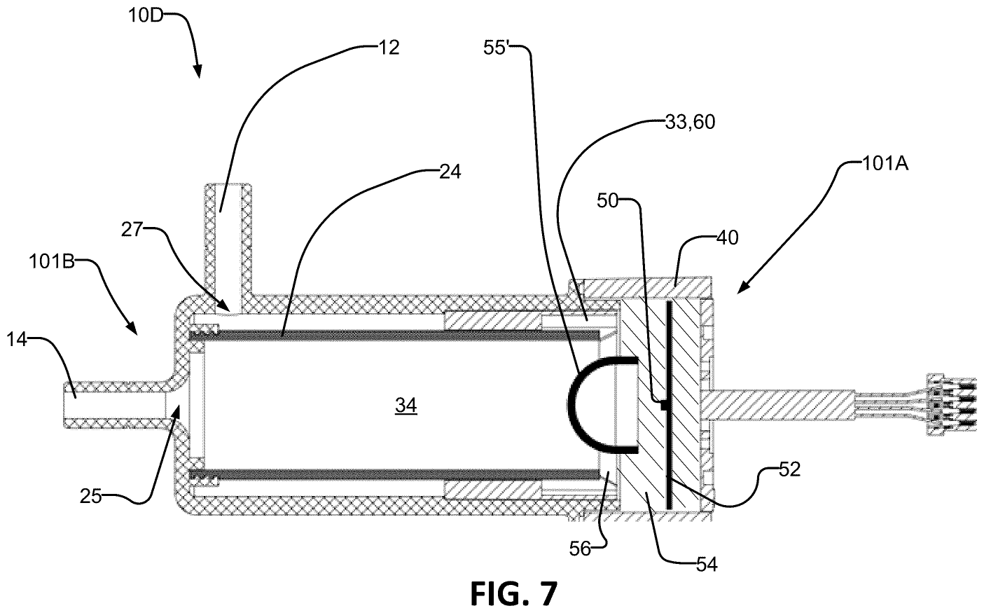

FIG. 7 is a side section view of an UV reactor 10D according to another example embodiment of the invention. UV reactor 10D may, but need not, comprise any of the features discussed herein in reference to any of the other UV reactors described herein. Like numbering may denote like features between UV reactor 10D and the other UV reactors described herein. UV reactor 10D comprises curved UV-transparent window 55′ which may be curved (over at least a portion (e.g. its UV-transparent region) thereof). The curved portion of UV-transparent window 55′ may comprise a constant radius of curvature or curved (e.g. over its UV-transparent region) or a varied radius of curvature (e.g. over its UV-transparent region). Curved UV-transparent window 55′ may be fabricated from any of the materials discussed herein in relation to UV-transparent window 55. A concave surface of curved window 55′ may be more proximate to (e.g. may face) UV radiation emitters 50 than a convex surface of curved window 55′ which may face inner reactor chamber 34. Advantageously, curved window 55′ may allow a greater percentage of UV radiation power from UV radiation emitters 50 to be transmitted to inner chamber 34 (greater light utilization efficiency) than the generally planar shaped window 55. This greater percentage power transmission is because the UV-transparent materials used to fabricate windows 55, 55′ are typically not perfectly transmissive and radiation with angles of incidence that are further from normal (closer to tangential) to the surface of windows 55, 55′ may be reflected rather than transmitter and because the curved nature of curved window 55′ may allow the angle of incidence of a greater percentage of radiation from radiation emitters 50 to be suitable to transmission instead of reflection (i.e. angles of incidence closer to normal and further from tangential to the curved surface of window 55′) in comparison to window 55 (where the angles of incidence of a greater percentage of radiation from radiation emitters 50 will tend to be closer to tangential and further from normal to the planar surface of window 55).

Curved window 55′ may be secured to cap 40 (e.g. to heat-conducting insert member 54 and/or heat-conducting frame 56) using a radial seal between a surface of window 55 that has a surface normal close to (e.g. within 15° of) orthogonal to longitudinal directions 101 and a complementary surface of cap 40 (e.g. a surface of insert 54 and/or heat-conducting frame 56) that has surface normal similarly close to (e.g. within 15° of) orthogonal to longitudinal directions 101. Such radial sealing between window 55′ and cap 40 (e.g. heat-conducting insert member 54 and/or heat-conducting frame 56) may be effected at least in part by an O-ring located between the surfaces. Such radial sealing between window 55′ and cap 40 (e.g. heat-conducting insert member 54 and/or heat-conducting frame 56) may advantageously lower costs and associated work required to manufacture reactor 10D. As discussed above, heat-conducting insert 54 and heat conducting frame 56 may be in thermal contact with the PCB substrate 52 supporting radiation emitter(s) 50. Curved window 55′ may allow for more effective heat transfer between fluid 2 and UV radiation emitters 50 in comparison to window 55. The extension of curved window 55′ in directions orthogonal to longitudinal directions 101 may be smaller than the extension of window 55 in directions orthogonal to longitudinal directions 101. The shorter extension of curved window 55′ in such directions may leave a greater surface area of frame 56 exposed to fluid 2 and a greater surface area of insert 54 in thermal contact with frame 56 (relative to the surface areas of frame 56 and insert 54 in embodiments using planar window 55), thereby allowing more heat transfer between, or heat transfer to occur more rapidly between, fluid 2 and UV radiation emitters 50 when compared to embodiments which use planar window 55.

Like UV reactor 10 described above, UV reactors 10A, 10B, 10C, 10D, may optionally comprise a number of suitable supplementary features for enhancing reactor performance. These features include, without limitation: one or more diffusers 60 located in outer reactor chamber(s) 32, a reflector cone 70 disposed around UV radiation emitters 50, one or more lenses 80 located UV radiation emitters 50 and their respective windows 55, one or more suitably located and oriented mirrors and/or reflective surfaces for reflecting UV radiation emitted by UV radiation emitters 50, etc.

In some embodiments, any surface of any component of UV reactor 10, 10A, 10B, 10C, 10D, may be coated with a UV reflective material to enhance the performance of UV reactor 10, 10A, 10B, 10C, 10D. For example, end wall portion 24B of inner body member 24 may comprise a UV reflective material facing toward UV radiation emitters 50 to reflect UV radiation back toward inner reactor chamber 34.

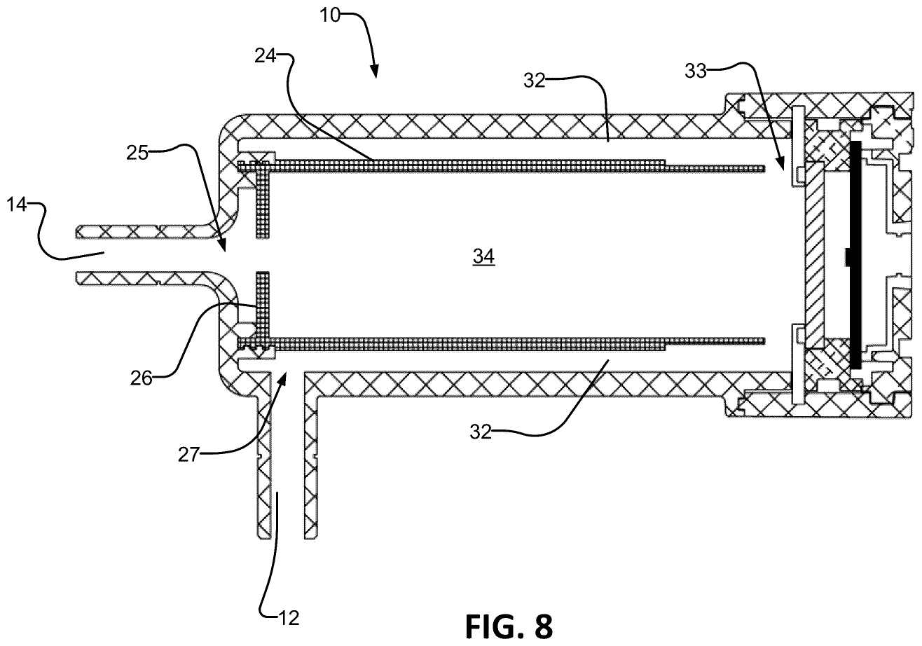

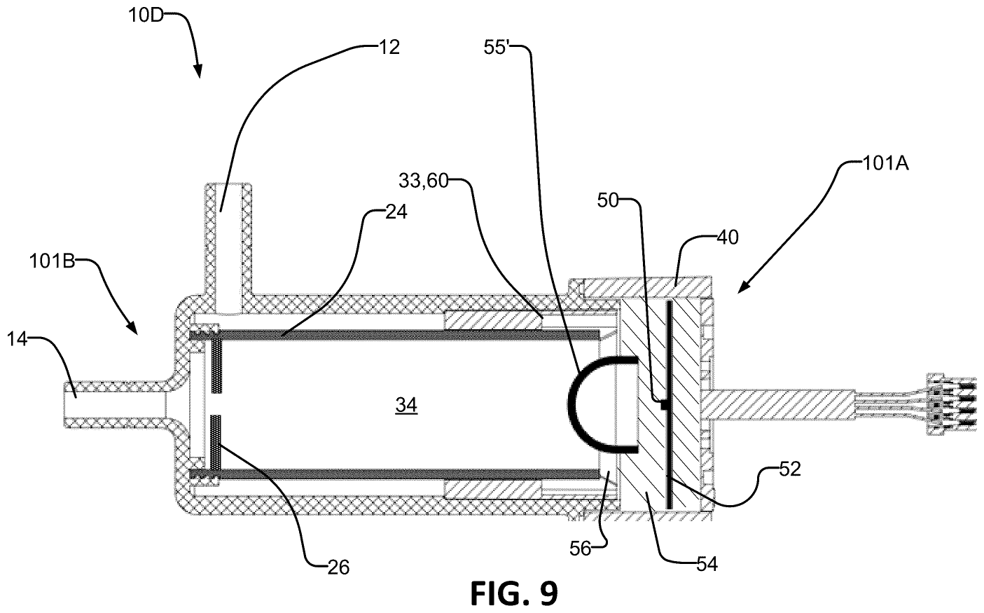

In some embodiments, inner body member 24 of UV reactors 10, 10A, 10B, 10C, 10D may comprise one or more transversely extending members 26 that extend in one or more directions that have at least one directional component that is orthogonal to longitudinal axis 101. Such transversely extending members 26 may be located proximal to outlet 14 and/or second longitudinal end 101B, although this is not necessary and such transversely extending members 26 may be located at any suitable location. Such transversely extending members 26 may be integrally formed with other portions of inner body member or may be coupled thereto. Any component, portion and/or surface of inner body member 24 (including transversely extending members 26) may comprise or be coated in a reflective material. FIG. 8 shows a side section view of reactor 10, where inner body member 24 comprises one or more transversely extending members 26 that extend in directions that have at least one directional component that is orthogonal to longitudinal directions 101. FIG. 9 shows a side section view of the FIG. 7 reactor 10D where inner body member 24 comprises one or more transversely extending members 26 that extend in directions that have at least one directional component that is orthogonal to longitudinal axis 101. Any component, portion and/or surface of transversely extending members 26 may comprise or be coated in a reflective material which may reflect radiation back into inner reactor chamber 34 to provide greater radiation fluence in inner reactor chamber 34. It will be appreciated that transversely extending members 26 may be provided on any of the other reactors described herein. In some embodiments, inner body member 24 may be fabricated from transparent material while any component, portion and/or surface of outer body member 22 (e.g. tubular portion 22A and end wall portion 22B) may comprises or be coated with a reflective materials, so that radiation penetrates through inner body member 24 but is reflected back into inner body member 24 by the inwardly facing surfaces of outer body member 22.

In some embodiments, UV reactor 10, 10A, 10B, 100, 10D includes one or more mechanical mixing elements (e.g. baffles) located in outer reactor chamber 32 and/or inner reactor chamber 34. The mechanical mixing elements may be operated to further control the hydrodynamics of fluid 2 flowing through reactor body 20 (e.g. remove short circuit flow streams, match the flow regime of fluid 2 with the radiation profile generated by UV emitters 50, etc.). This can further enhance the performance of UV reactor 10, 10A, 10B, 10C, 10D.

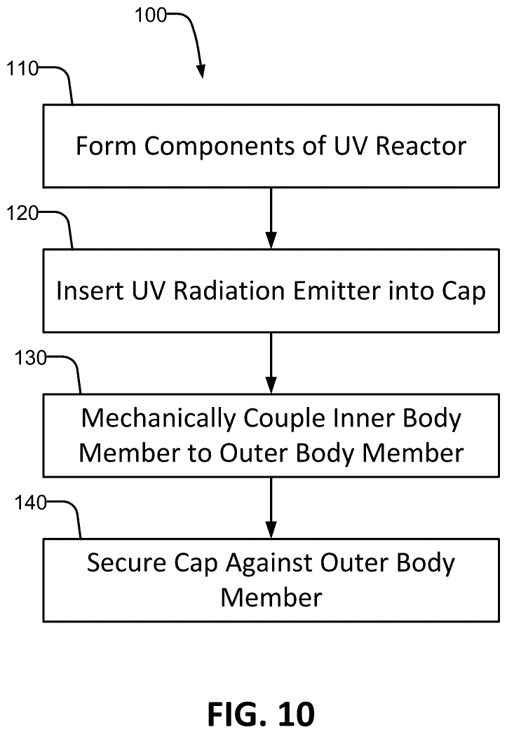

FIG. 10 is a flowchart of a method 100 of manufacturing a UV reactor of the type shown in FIG. 1. Method 100 begins at step 110. Step 110 comprises forming the various individual components of UV reactor 10. For example, step 110 may comprise forming outer body member 22, inner body member 24, and cap 40. These components may be formed using any suitable method. In some embodiments, these components are formed through bulk manufacturing processes such as injection molding, or the like. After forming outer body member 22, inner body member 24, and cap 40, method 100 proceeds to step 120.

Step 120 comprises mounting UV radiation emitter 50 in cap 40. Mounting UV radiation emitter 50 in cap 40 may comprise optically orienting UV radiation emitter 50 to face toward the opening of cap 40, inserting UV radiation emitter 50 into cavity 41 of cap 40, and securing UV transparent window 55 at the opening to prevent fluid 2 from flowing into cavity 41 and contacting UV radiation emitter 50 (i.e. when UV reactor 10 is in operation). In some embodiments, step 120 comprises securing UV radiation emitter 50 to a thermally conductive insert 54 located in cavity 41. After placing UV radiation emitter 50 into cap 40, method 100 proceeds to step 130.

Step 130 comprises mechanically coupling inner body member 24 to outer body member 22. In some embodiments, mechanically coupling inner body member 24 to outer body member 22 comprises connecting a rim 24D of inner body member 24 to an attachment mechanism located at the end wall portion 22B of outer body member 22 (e.g. see FIG. 1B). The attachment mechanism of outer body member 22 may comprise a threaded connection, a friction fit, a snap (restorative deformation) fit, etc. In some embodiments, the rim 24D of inner body member 24 is connected to the end wall portion 22B of outer body member 22 by inserting inner body member 24 into the bore defined by the tubular portion 22A of outer body member 22 through an opening of outer body member 22 located at first longitudinal end 101A. After mechanically coupling inner body member 24 to outer body member 22 in such fashion, method 100 proceeds to step 140.

Step 140 comprises securing cap 40 with UV radiation emitters 50 housed therein to outer body member 22 at first longitudinal end 101A. Step 140 may comprise permanently securing cap 40 to outer body member 22 or detachably coupling cap 40 to outer body member 22. Cap 40 may be secured to outer body member 22 through a threaded connection, a friction fit, a snap (restorative deformation) fit, etc. Securing cap 40 to outer body member 22 at the first longitudinal end 101A encloses inner body member 24 within outer body member 22 to define inner reactor chamber 32 and outer reactor chamber 34.

A number of additional features and/or variations of features are possible in the practice of various embodiments. By way of non-limiting example:
baffles or other mixing elements may be provided in the outer reactor chamber 34 and/or in the inner reactor chamber 32. Such baffles or other mixing elements may be integrally formed with or connected to outer body member 22 and/or inner body member 24. Such baffles or other mixing elements may function to mix or otherwise disrupt the flow of fluids in their respective reactor chambers. The baffles or mixing other elements in the inner reactor chamber 32 may be UV-transparent, so that they do not unduly impede the delivery of radiation to fluid in inner reactor chamber 32.
diffusers 60 described elsewhere herein are made from solid bodies 62 with perforations 64. In some embodiments, diffusers 60 may comprise a mesh or other porous material, which diffuses fluid flow as the flow passes therethrough.
In some embodiments, various body components of various reactor embodiments are molded (e.g. injection molded). In some embodiments, the materials used to make various body components are fabricated from UV-resistant materials (i.e. materials that do not break down appreciably when irradiated with UV radiation. In some embodiments, various body components may be molded in a one-body mold. For example, in some embodiments, inlet 12 and/or outlet 14 may be molded in a one-body mold with outer body member 22. In some embodiments, various body components may be insert molded or over-molded to provide joints between such body components. For example, inner body member 24 may be insert molded into outer body member 22 (e.g. at the second longitudinal end 101B (see FIGS. 1A, 1B, 2) or elsewhere.
wiring may be provided to power UV radiation emitters 50 via a sealed conduit into the concavity 41 of cap 40 via a portion of cap 40 that faces away from inner reactor chamber 34.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

The invention has a number of non-limiting aspects. Non-limiting aspects of the invention include:
1. An ultraviolet (UV) reactor for treating water or other fluids, the UV reactor comprising:
   a reactor body shaped to define inner and outer reactor chambers which extend in a longitudinal direction, the inner reactor chamber having one or more passages located at a first longitudinal end of the inner reactor chamber which provide fluid communication between the inner reactor chamber and the outer reactor chamber, the outer reactor chamber shaped to surround at least a portion of the inner reactor chamber that includes the first longitudinal end of the inner reactor chamber;
   an inlet/outlet in fluid communication with the outer reactor chamber;
   an outlet/inlet in fluid communication with at least one of the inner reactor chamber and the outer reactor chamber; and
   a cap housing one or more UV radiation emitters, the cap operatively connected to the reactor body, the one or more UV radiation emitters optically oriented to direct UV radiation into the inner reactor chamber,
   wherein a first fluid-flow cross-section at an opening between the inlet/outlet and the outer reactor chamber is less than a minimum fluid-flow cross-section of the one or more passages.
2. The UV reactor of aspect 1 or any other aspect herein wherein the inlet/outlet is in fluid communication with the outer reactor chamber at a location spaced longitudinally apart from the first longitudinal end of the reactor chamber.
3. The UV reactor of any one of aspects 1 to 2 or any other aspect herein wherein the outlet/inlet is in fluid communication with the inner reactor chamber at a second longitudinal end of the inner reactor chamber, the second longitudinal end of the inner reactor chamber opposed to the first longitudinal end of the inner reactor chamber.
4. The UV reactor of any one of aspects 1 to 3 or any other aspect herein wherein a first average fluid velocity through the opening in a direction orthogonal to the first fluid-flow cross-section is greater than a second average velocity through the minimum fluid-flow cross-section in a direction orthogonal to the minimum fluid-flow cross-section.
5. An ultraviolet (UV) reactor for treating water or other fluids, the UV reactor comprising:
   a reactor body shaped to define inner and outer reactor chambers which extend in a longitudinal direction, the inner reactor chamber having one or more passages located at a first longitudinal end of the inner reactor chamber which provide fluid communication between the inner reactor chamber and the outer reactor chamber, the outer reactor chamber shaped to surround at least a portion of the inner reactor chamber that includes the first longitudinal end of the inner reactor chamber;
   an inlet/outlet in fluid communication with the outer reactor chamber;
   an outlet/inlet in fluid communication with at least one of the inner reactor chamber and the outer reactor chamber; and
   a cap housing one or more UV radiation emitters, the cap operatively connected to the reactor body, the one or more UV radiation emitters optically oriented to direct UV radiation into the inner reactor chamber,
   wherein an inner fluid-flow cross-section of the inner reactor chamber in a cross-sectional plane having a normal parallel to the longitudinal direction is greater than an outer fluid flow cross-section of the outer reactor chamber in the cross-sectional plane.
6. The UV reactor of aspect 5 or any other aspect herein wherein the inlet/outlet is in fluid communication with the outer reactor chamber at a location spaced longitudinally apart from the first longitudinal end of the reactor chamber.
7. The UV reactor of any one of aspects 5 to 6 or any other aspect herein wherein the outlet/inlet is in fluid communication with the inner reactor chamber at a second longitudinal end of the inner reactor chamber, the second longitudinal end of the inner reactor chamber opposed to the first longitudinal end of the inner reactor chamber.
8. The UV reactor of any one of aspects 5 to 7 or any other aspect herein wherein an inner average velocity of the fluid in the inner reactor chamber is less than an outer average velocity of the fluid in the outer reactor chamber.
9. The UV reactor of any one of aspects 1 to 8 or any other aspect herein wherein the inlet/outlet is in fluid communication with the outer reactor chamber at a location spaced longitudinally apart from the first longitudinal end of the outer reactor chamber.
10. The UV reactor of any one of aspects 1 to 9 or any other aspect herein, wherein the inner fluid-flow cross-section of the inner reactor chamber is greater than an inlet fluid-flow cross-section of the inlet in an inlet cross-sectional plane having a normal parallel to a flow direction in the inlet.
11. The UV reactor of any one of aspects 1 to 10 or any other aspect herein, wherein the inner fluid-flow cross-section of the inner reactor chamber is greater than an outlet fluid-flow cross-section of the outlet in an outlet cross-sectional plane having a normal parallel to a flow direction in the outlet.
12. The UV reactor of any one of aspects 1 to 11 or any other aspect herein, wherein the outer fluid-flow cross-section of the outer reactor chamber is greater than an inlet fluid-flow cross-section of the inlet in an inlet cross-sectional plane having a normal parallel to a flow direction in the inlet.
13. The UV reactor of any one of aspects 1 to 12 or any other aspect herein, wherein the outer fluid-flow cross-section of the outer reactor chamber is greater than an outlet fluid-flow cross-section of the outlet in an outlet cross-sectional plane having a normal parallel to a flow direction in the outlet.
14. The UV reactor of any one of aspects 1 to 13 or any other aspect herein, wherein the reactor body comprises:
   an inner body member having a tubular portion which extends in the longitudinal direction and an inner surface which defines the inner reactor chamber; and
   an outer body member having a tubular portion and an end wall portion located at the second longitudinal end of the outer reactor chamber, the end wall portion shaped to have an opening, an interior surface of the tubular portion and an outer surface of the inner body member collectively defining the outer reactor chamber,
   wherein the inner body member is connected to the outer body member at the second longitudinal end of the outer reactor chamber.
15. The UV reactor according to aspect 14 or any other aspect herein wherein the inner body member comprises a transversely extending member that extends in at least one direction that has a directional component that is orthogonal to the longitudinal direction.
16. The UV reactor according to aspect 15 or any other aspect herein wherein the transversely extending member is proximal to the second longitudinal end and at least a surface of the transversely extending member facing the first longitudinal end is reflective of the UV radiation emitted by the UV radiation emitters.
17. The UV reactor according to any one of aspects 15 to 16 or any other aspect herein wherein the transversely extending member is proximal to the outlet/inlet and at least a surface of the transversely extending member facing the first longitudinal end is reflective of the UV radiation emitted by the UV radiation emitters.
18. The UV reactor according to any one of aspects 14 to 17 or any other aspect herein, wherein the inlet/outlet is defined in the tubular portion of the outer body member.
19. The UV reactor according to any one of aspects 14 to 18 or any other aspect herein, wherein outlet/inlet is defined in the end wall portion of the outer body member.
20. The UV reactor according to any one of aspects 14 to 19 or any other aspect herein, wherein the cap is operatively connected to the outer body member at the first longitudinal end of the outer reactor chamber.
21. The UV reactor of aspect 20 or any other aspect herein, wherein the cap is permanently secured to the outer body member at the first longitudinal end.
22. The UV reactor of aspect 20 or any other aspect herein, wherein the cap is detachably coupled to the outer body member at the first longitudinal end.
23. The UV reactor of aspect 22 or any other aspect herein, wherein the cap is detachably coupled to the outer body member by way of one or more of a threaded connection, a snap-fit and o-ring seals.
24. The UV reactor of any one of aspects 14 to 23 or any other aspect herein, wherein the inner surface of the inner body member comprises a UV reflective material.
25. The UV reactor of aspect 24 or any other aspect herein, wherein the UV reflective material is a dominantly diffuse UV reflective material suitable for reflecting UV radiation emitted by the one or more UV radiation emitters in a predominantly diffuse fashion.
26. The UV reactor of any one of aspects 14 to 25 or any other aspect herein, wherein the inner surface of the inner body member is coated with a protective layer of UV-transparent material.
27. The UV reactor of any one of aspects 14 to 23 or any other aspect herein wherein the inner body member is transparent.
28. The UV reactor of any one of aspects 14 to 26 or any other aspect herein, wherein the interior surface of the tubular portion of the outer body member comprises a UV reflective material.
29. The UV reactor of aspect 28 or any other aspect herein, wherein the UV reflective material on the interior surface of the tubular portion of the outer body member is a dominantly specular UV reflective material suitable for reflecting UV radiation emitted by the one or more UV radiation emitters in a predominantly specular fashion.
30. The UV reactor of aspect 28 or any other aspect herein, wherein the UV reflective material on the interior surface of the tubular portion of the outer body member is a dominantly diffuse UV reflective material suitable for reflecting UV radiation emitted by the one or more UV radiation emitters in a predominantly diffuse fashion.
31. The UV reactor of any one of aspects 14 to 30 or any other aspect herein, wherein an inner surface of the end wall portion of the outer body member comprises a UV reflective material.
32. The UV reactor of any one of aspects 14 to 31 or any other aspect herein, wherein the inner body member and the tubular portion of the outer body member are annular in cross-section in the cross-sectional plane.
33. The UV reactor of aspect 32 or any other aspect herein, wherein the inner body member and the tubular portion of the outer body member are co-centric.
34. The UV reactor of any one of aspects 14 to 33 or any other aspect herein, further comprising a diffuser located in the outer reactor chamber, the diffuser having a diffuser body and a plurality of perforations extending through the diffuser body.
35. The UV reactor of aspect 34 or any other aspect herein, wherein the diffuser body is tubular shaped to conform to the shape of the inner body member and the tubular portion of the outer body member.
36. The UV reactor of aspect 34 or any other aspect herein, wherein the diffuser body is connected to the outer surface of the inner body member and connected to the tubular portion of the outer body member.
37. The UV reactor of any one of aspects 35 to 36 or any other aspect herein, wherein the perforations are spaced circumferentially around the tubular shaped diffuser body.
38. The UV reactor of aspect 37 or any other aspect herein, wherein the perforations are evenly spaced around the circumference of the diffuser body.
39. The UV reactor of any one of aspects 34 to 38 or any other aspect herein, wherein the perforations are circular, triangular, rectangular, or hexagonal shaped in cross-section.
40. The UV reactor of any one of aspects 34 to 39 or any other aspect herein, wherein the perforations extend in directions parallel to the longitudinal direction.
41. The UV reactor of any one of aspects 34 to 39 or any other aspect herein, wherein the perforations extend in directions that have a component orthogonal to the longitudinal direction.
42. The UV reactor of any one of aspects 34 to 41 or any other aspect herein, wherein adjacent ones of the plurality of perforations are different in size.
43. The UV reactor of any one of aspects 14 to 33 further comprising a diffuser located in the outer reactor chamber, the diffuser comprising a mesh or other porous material.
44. The UV reactor of any one of aspects 1 to 43 or any other aspect herein, wherein the one or more UV radiation emitters are located in a cavity of the cap, and wherein the cap comprises a UV-transparent window positioned to isolate the one or more UV radiation emitters from the fluid flowing through the reactor body.
45. The UV reactor according to aspect 44 or any other aspect herein wherein the UV-transparent window comprises a curved portion, the curved portion comprising a concave surface facing the one or more UV radiation emitters and a convex surface facing the inner reactor chamber.
46. The UV reactor according to aspect 45 or any other aspect herein wherein the curved portion comprises a varying radius of curvature.
47. The UV reactor according to aspect 45 or any other aspect herein wherein the curved portion comprises a constant radius of curvature.
48. The UV reactor according to any one of aspects 45 to 47 or any other aspect herein comprising a radial seal between a first surface of the UV transparent window that has a first surface normal within 15° of orthogonal to the longitudinal direction and a complementary surface of the cap or a heat-conducting insert located in a concavity of the cap, the complementary surface having a complementary surface normal within 15° of orthogonal to the longitudinal direction.
49. The UV reactor according to aspect 48 or any other aspect herein wherein the radial seal is effected at least in part by an O-ring located between the first surface and the complementary surface.
50. The UV reactor according to any one of aspects 45 to 49 or any other aspect herein wherein the extension of the UV-transparent window in directions orthogonal to the longitudinal direction is less than a dimension on the inner reactor chamber in such directions.
51. The UV reactor of any one of aspects 44 to 50 or any other aspect herein, further comprising a reflector cone disposed around the one or more UV radiation emitters.
52. The UV reactor of any one of aspects 44 to 51 or any other aspect herein, further comprising one or more lenses located between the one or more UV radiation emitters and the UV-transparent window.
53. The UV reactor of any one of aspects 44 to 52 or any other aspect herein, wherein the one or more UV radiation emitters is supported by a thermally conductive insert, the thermally conductive insert in thermal contact with the inner reactor chamber and/or outer reactor chamber of the reactor body.
54. The UV reactor of any one of aspects 1 to 53 or any other aspect herein comprising one or more mixing elements located in the outer reactor chamber.
55. The UV reactor of any one of aspects 1 to 54 or any other aspect herein comprising one or more inner-chamber mixing elements located in the inner reactor chamber.
56. The UV reactor of aspect 55 or any other aspect herein wherein the inner-chamber mixing elements are transparent to UV radiation.
57. The UV reactor of any one of aspects 14 to 43 or any other aspect herein wherein the inner body member is connected to the outer body member by insert molding.
58. The UV reactor of any one of aspects 14 to 43 and 57 wherein at least one of the inlet/outlet and the outlet/inlet is integrally formed with the outer body member in a one body mold.
59. The UV reactor of any one of aspects 14 to 43, 57 and 58 or any other aspect herein wherein the inner body member and outer body member are fabricated from UV-resistant material.
60. The UV reactor of any one of aspects 1 to 59 wherein electrical power is provided to the one or more UV radiation emitters via a sealed conduit into the concavity of the cap via a portion of the cap that faces away from the inner reactor chamber.
61. A method of manufacturing the UV reactor of any one of aspects 14 to 43, 57, 58 and 59 or any other aspect herein, the method comprising:
   forming the inner body member, the outer body member, and the cap;
   mounting the one or more UV radiation emitters in the cavity of the cap and optically orienting the one or more UV radiation emitters to face toward the opening of the cap;
   securing the UV transparent window to an inner side wall of the cap at a location between the opening of the cap and the one or more UV radiation emitters;
   coupling a rim of the inner body member to the outer body member at a second longitudinal end of the outer reactor chamber; and
   coupling the opening of the cap with the one or more UV radiation emitters housed therein to the outer body member.
62. The method of manufacturing according to aspect 61 or any other aspect herein, wherein mounting the one or more UV radiation emitters in the cavity comprises coupling the one or more UV radiation emitters to the thermally conductive insert.
63. The method of manufacturing according to aspect 62 or any other aspect herein, wherein the coupling of the one or more UV radiation emitters to the insert comprises insert molding of the one or more UV radiation emitters to the insert.
64. An ultraviolet (UV) reactor for disinfecting water or other fluids, the UV reactor comprising:
   a reactor body shaped to define primary and secondary reactor chambers which extend in a longitudinal direction and one or more passages located at a first longitudinal end of the primary reactor chamber which provide fluid communication between the primary reactor chamber and the secondary reactor chamber;
   an inlet/outlet in fluid communication with the secondary reactor chamber at a location spaced longitudinally apart from the first longitudinal end of the primary reactor chamber;
   an outlet/inlet in fluid communication with the primary reactor chamber at a second longitudinal end of the primary reactor chamber, the second longitudinal end of the primary reactor chamber opposed to the first longitudinal end of the primary reactor chamber; and
   a housing supporting one or more UV radiation emitters, the housing operatively connected to the reactor body, the one or more UV radiation emitters optically oriented to direct UV radiation into the primary reactor chamber,
   wherein a fluid-flow cross-section of the primary reactor chamber in a first cross-sectional plane having a normal parallel to the longitudinal direction is greater than a fluid flow cross-section of the secondary reactor chamber in a second cross-sectional plane having a second normal parallel to the longitudinal direction to thereby cause a first average velocity of the fluid in the primary reactor chamber to be less than a second average velocity of the fluid in the secondary reactor chamber.
65. The UV reactor of aspect 64 comprising any of the features, combinations of features or sub-combinations of features of any other aspect herein.
66. Apparatus having any new and inventive feature, combination of features, or sub-combination of features as described herein.
67. Methods having any new and inventive steps, acts, combination of steps and/or acts or sub-combination of steps and/or acts as described herein.

The invention includes a number of non-limiting further aspects. Non-limiting further aspects of the invention provide:

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

1. An ultraviolet (UV) reactor for treating water or other fluids, the UV reactor comprising:
a reactor body shaped to define inner and outer reactor chambers which extend in a longitudinal direction, the inner reactor chamber having one or more passages located at a first longitudinal end of the inner reactor chamber which provide fluid communication between the inner reactor chamber and the outer reactor chamber, the outer reactor chamber shaped to surround at least a portion of the inner reactor chamber that includes the first longitudinal end of the inner reactor chamber;
an inlet/outlet in fluid communication with the outer reactor chamber;
an outlet/inlet in fluid communication with at least one of the inner reactor chamber and the outer reactor chamber; and
a cap housing one or more UV radiation emitters, the cap operatively connected to the reactor body, the one or more UV radiation emitters optically oriented to direct UV radiation into the inner reactor chamber,
wherein a first fluid-flow cross-section at an opening between the inlet/outlet and the outer reactor chamber is less than a minimum fluid-flow cross-section of the one or more passages.

2. The UV reactor of claim 1 wherein the inlet/outlet is in fluid communication with the outer reactor chamber at a location spaced longitudinally apart from the first longitudinal end of the reactor chamber.

3. The UV reactor of claim 1 wherein the outlet/inlet is in fluid communication with the inner reactor chamber at a second longitudinal end of the inner reactor chamber, the second longitudinal end of the inner reactor chamber opposed to the first longitudinal end of the inner reactor chamber.

4. The UV reactor of claim 1 wherein a first average fluid velocity through the opening in a direction orthogonal to the first fluid-flow cross-section is greater than a second average velocity through the minimum fluid-flow cross-section in a direction orthogonal to the minimum fluid-flow cross-section.

5. An ultraviolet (UV) reactor for treating water or other fluids, the UV reactor comprising:
a reactor body shaped to define inner and outer reactor chambers which extend in a longitudinal direction, the inner reactor chamber having one or more passages located at a first longitudinal end of the inner reactor chamber which provide fluid communication between the inner reactor chamber and the outer reactor chamber, the outer reactor chamber shaped to surround at least a portion of the inner reactor chamber that includes the first longitudinal end of the inner reactor chamber;
an inlet/outlet in fluid communication with the outer reactor chamber;
an outlet/inlet in fluid communication with at least one of the inner reactor chamber and the outer reactor chamber; and
a cap housing one or more UV radiation emitters, the cap operatively connected to the reactor body, the one or more UV radiation emitters optically oriented to direct UV radiation into the inner reactor chamber,
wherein an inner fluid-flow cross-section of the inner reactor chamber in a cross-sectional plane having a normal parallel to the longitudinal direction is greater than an outer fluid flow cross-section of the outer reactor chamber in the cross-sectional plane.

6. The UV reactor of claim 5 wherein the inlet/outlet is in fluid communication with the outer reactor chamber at a location spaced longitudinally apart from the first longitudinal end of the reactor chamber.

7. The UV reactor of claim 5 wherein the outlet/inlet is in fluid communication with the inner reactor chamber at a second longitudinal end of the inner reactor chamber, the second longitudinal end of the inner reactor chamber opposed to the first longitudinal end of the inner reactor chamber.

8. The UV reactor of claim 5 wherein an inner average velocity of the fluid in the inner reactor chamber is less than an outer average velocity of the fluid in the outer reactor chamber.

9. The UV reactor of claim 1 wherein the inlet/outlet is in fluid communication with the outer reactor chamber at a location spaced longitudinally apart from the first longitudinal end of the outer reactor chamber.

10. The UV reactor of claim 1 wherein the inner fluid-flow cross-section of the inner reactor chamber is greater than an inlet fluid-flow cross-section of the inlet in an inlet cross-sectional plane having a normal parallel to a flow direction in the inlet.

11. The UV reactor of claim 1 wherein the inner fluid-flow cross-section of the inner reactor chamber is greater than an outlet fluid-flow cross-section of the outlet in an outlet cross-sectional plane having a normal parallel to a flow direction in the outlet.

12. The UV reactor of claim 1 wherein the outer fluid-flow cross-section of the outer reactor chamber is greater than an inlet fluid-flow cross-section of the inlet in an inlet cross-sectional plane having a normal parallel to a flow direction in the inlet.

13. The UV reactor of claim 1 wherein the outer fluid-flow cross-section of the outer reactor chamber is greater than an outlet fluid-flow cross-section of the outlet in an outlet cross-sectional plane having a normal parallel to a flow direction in the outlet.

14. The UV reactor of claim 1 wherein the reactor body comprises:
an inner body member having a tubular portion which extends in the longitudinal direction and an inner surface which defines the inner reactor chamber; and
an outer body member having a tubular portion and an end wall portion located at the second longitudinal end of the outer reactor chamber, the end wall portion shaped to have an opening, an interior surface of the tubular portion and an outer surface of the inner body member collectively defining the outer reactor chamber,
wherein the inner body member is connected to the outer body member at the second longitudinal end of the outer reactor chamber.

15. The UV reactor of claim 14 wherein the inner body member comprises a transversely extending member that extends in at least one direction that has a directional component that is orthogonal to the longitudinal direction.

16. The UV reactor of claim 15 wherein the transversely extending member is proximal to the second longitudinal end and at least a surface of the transversely extending member facing the first longitudinal end is reflective of the UV radiation emitted by the UV radiation emitters.

17. The UV reactor of claim 15 wherein the transversely extending member is proximal to the outlet/inlet and at least a surface of the transversely extending member facing the first longitudinal end is reflective of the UV radiation emitted by the UV radiation emitters.

18. The UV reactor according to claim 14 wherein the inlet/outlet is defined in the tubular portion of the outer body member.

19. The UV reactor according to claim 14 wherein outlet/inlet is defined in the end wall portion of the outer body member.

20. The UV reactor according to claim 14 wherein the cap is operatively connected to the outer body member at the first longitudinal end of the outer reactor chamber.
